(19) United States
(12) Patent Application Publication
(10) Pub. No.: US 2014/0093289 A1
(43) Pub. Date: Apr. 3, 2014

(54) IMAGE FORMING APPARATUS

(71) Applicants: Hiroki ISHII, Kanagawa (JP); Hyo Shu, Shizuoka (JP); Wakana Itoh, Kanagawa (JP); Takuma Higa, Kanagawa (JP)

(72) Inventors: Hiroki ISHII, Kanagawa (JP); Hyo Shu, Shizuoka (JP); Wakana Itoh, Kanagawa (JP); Takuma Higa, Kanagawa (JP)

(21) Appl. No.: 14/025,013

(22) Filed: Sep. 12, 2013

(30) Foreign Application Priority Data
Sep. 28, 2012 (JP) 2012-215790

(51) Int. Cl. G03G 15/20

(52) U.S. Cl. CPC G03G 9/08755; G03G 15/2057
USPC 399/329; 399/333

(57) ABSTRACT

An image forming apparatus has a system velocity of 400 to 1,700 mm/sec and includes a fixing belt including a base layer; a silicon rubber layer; and a fluorine resin layer. A thickness L2 of the fluorine resin layer is in range of 2≦L2≦20 μm. A thickness L1 of the silicone rubber layer is in range of 400≦L1≦750 μm. The toner includes a release agent and a binder resin including a crystalline polyester resin and an amorphous polyester resin. A ratio W/R of a height W of third falling peak of an infrared absorption spectrum of the crystalline polyester resin to a height R of the maximum rising peak of an infrared absorption spectrum of the amorphous polyester resin is from 0.045 to 0.850. The content of inorganic fine particles is 0.80 to 5.00 parts per 100 parts of toner base particles.

### CROSS-REFERENCE TO RELATED APPLICATIONS

The present application claims priority to and incorporates by reference the entire contents of Japanese Patent Application No. 2012-215790 filed in Japan on Sep. 28, 2012.

### BACKGROUND OF THE INVENTION

1. Field of the Invention

The present invention relates to an image forming apparatus, such as a copier, a printer, and a facsimile, which can form images at high speed.

2. Description of the Related Art

In these years, in an image forming apparatus such as a copier, a printer, and a facsimile, it is demanded to increase speed and to provide high image quality. From the viewpoint of increasing speed, a so-called high-speed machine is implemented, which can form images at high speed as at a velocity of 400 to 1,700 mm/sec.

However, when images are formed at high speed, gloss unevenness, which is one of factors to deeply affect image quality, is degraded to sometimes cause image quality to become worse. A cause of gloss unevenness is that the quantity of heat to be applied to toner used for forming images becomes insufficient in association with an increase in speed and a wax in the inside of a toner particle is not uniformly and instantaneously exuded to the toner surface. When gloss unevenness is degraded, problems of image quality possibly arise such as the occurrence of color difference or image density difference, or a change in a color reproduction range depending on the positions of an image.

Therefore, it is necessary to combine an increase in speed and the prevention or suppression of degraded image quality caused by gloss unevenness. In order to satisfy an increase in speed and the prevention or suppression of degraded image quality, it is necessary that the heat of a fixing device be easily transmitted to a toner image and a release agent included in toner be easily, uniformly, and instantaneously exuded to the toner particle surface.

For a scheme that is previously used and can achieve the easy transmission of heat and the exudation of the release agent, there is a scheme in which the fixing temperature is increased. However, since this scheme has a limitation from the viewpoint of a side effect caused by an increase in the temperature in the apparatus, the lifetime of a fixing member to be used up, and energy saving, the scheme is an insufficient scheme for improving gloss unevenness. Because of the situations, it is demanded for the high-speed machine to improve the fixing performance of toner itself. Namely, such a toner design is necessary that an excellent fixity be provided to toner even in a low quantity of heat for meeting a high-speed fixing process step in the fixing device.

Heretofore, various investigations are made on toner in order to easily exude a release agent to the toner surface.

For example, a method is known in which the heat characteristics of a resin used for toner are controlled in order to improve the fixing performance of toner itself. However, a reduction in the Tg (the glass transition temperature) of a resin causes the degradation of heat-resistant preservability or fixing strength. Moreover, when an F_{1/2} (a softening point) temperature is reduced by decreasing the molecular weight of a resin, problems arise such as the occurrence of hot offset and the influence on gloss control characteristics because gloss is too high. Because of the problems, there is not such toner yet that has an excellent low-temperature fixity and an excellent heat-resistant preservability and offset resistance characteristics by controlling the heat characteristics of a resin.

In addition to this, an attempt is made in which a polyester resin of excellent low-temperature fixity and relatively excellent heat-resistant preservability is used for toner instead of a styrene-acrylic resin which is often used previously (see Japanese Laid-open Patent Publication No. 60-90344, Japanese Laid-open Patent Publication No. 64-15755, Japanese Laid-open Patent Publication No. 02-82267, Japanese Laid-open Patent Publication No. 03-229264, Japanese Laid-open Patent Publication No. 03-41470, and Japanese Laid-open Patent Publication No. 11-305486, for example). Moreover, an attempt is made in which a binder is added with a specific non-olefin crystalline polymer which has sharp melting characteristics at a glass transition temperature in order to improve low-temperature fixity (see Japanese Laid-open Patent Publication No. 62-63940, for example). It is difficult to say that molecular structures and molecular weights are not optimized for a release agent to be easily exuded to the toner surface.

Furthermore, such toner is also proposed in which low-temperature fixity and heat-resistant preservability are combined by defining an sea-island phase separation structure formed of a crystalline polyester resin and an amorphous polyester resin, which are not compatible, or by defining the maximum peak temperature appearing on the heat absorption of a DSC curve measured by a differential scanning calorimeter for THF insolubles of a resin (see Japanese Laid-open Patent Publication No. 2002-214833, for example). However, it can be said that the effect is insufficient from the viewpoint of easily exuding a release agent to the toner surface.

In addition, such toner is proposed in which a crystalline polyester resin is rich (see Japanese Laid-open Patent Publication No. 2005-338814, for example). However, in the case where this toner is used in a high-speed machine, toner filming occurs to cause a problem of image quality because the reliability of image quality is insufficient.

As is generally known in an image forming apparatus like this, such a fixing device is widely used in which a fixing member and a pressing member in a roller shape or a belt shape are used for a unit to fix a toner image to a recording medium such as a paper sheet, a nip portion at which the fixing member contacts the pressing member is heated using a heater, and toner attached on the recording medium is fixed in passing the recording medium through the nip portion for obtaining a fixing image. For the configuration of the fixing member, such configurations are known as suited configurations in which a thermal storage layer is formed on a base layer, and a material of a large heat capacity and a large amount of heat transport is used for the thermal storage layer, and in which a releasing layer is provided on a thermal storage layer. However, under the present circumstances, it is difficult to say that even a high-speed imaging system using a high-speed machine does not sufficiently specify the material and characteristics of individual layers to some extent that gloss unevenness is eliminated.

As described above, it is insufficient to avoid gloss unevenness in a high-speed image forming system in such a way that a release agent is instantaneously exuded to the toner surface in fixing only using previously proposed techniques such as an increase in the fixing temperature and simple inclusion of a crystalline polyester resin in toner.

Therefore, there is a need for a high-speed image forming apparatus that sufficiently avoids gloss unevenness produced in fixing.

### SUMMARY OF THE INVENTION

According to an embodiment, there is provided an image forming apparatus that performs image formation using toner at a system velocity of 400 to 1,700 mm/sec. The image forming apparatus includes an endless fixing belt that transports a sheet medium on which a toner image is carried. The fixing belt includes a base layer; a rubber layer, as an elastic layer, formed of a silicon rubber on the base layer; and a releasing layer formed of a fluorine resin on the rubber layer. A layer thickness L2 of the fluorine resin is in a range of 2≦L2≦20 μm. A layer thickness L1 of the silicone rubber is in a range of 400≦L1≦750 μm. The toner includes at least a release agent and a binder resin, the binder resin including at least a crystalline polyester resin and an amorphous polyester resin. A ratio W/R of a height W of third falling peak of an infrared absorption spectrum of the crystalline polyester resin to a height R of the maximum rising peak of an infrared absorption spectrum of the amorphous polyester resin, which are measured by an infrared spectroscopy (a KBr pellet method) using Fourier transform infrared spectrometer, is 0.045 or more and 0.850 or less. The content of inorganic fine particles is from 0.80 to 5.00 parts per 100 parts of toner base particles.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic front view of an image forming apparatus to which the present invention is applied;

FIG. 2 is a detailed diagram of a fixing device for use in the image forming apparatus illustrated in FIG. 1;

FIG. 3 is a schematic front cross sectional view of a fixing belt for use in the fixing device illustrated in FIG. 2;

FIG. 4 is a graph of exemplary infrared absorption spectra of a crystalline polyester resin that is a component of an image forming toner for use in the image forming apparatus illustrated in FIG. 1; and

FIG. 5 is a graph of exemplary infrared absorption spectra of an amorphous polyester resin that is a component of an image forming toner for use in the image forming apparatus illustrated in FIG. 1.

### DETAILED DESCRIPTION OF THE PREFERRED EMBODIMENTS

In the following, an embodiment of the present invention will be described with reference to the drawings.

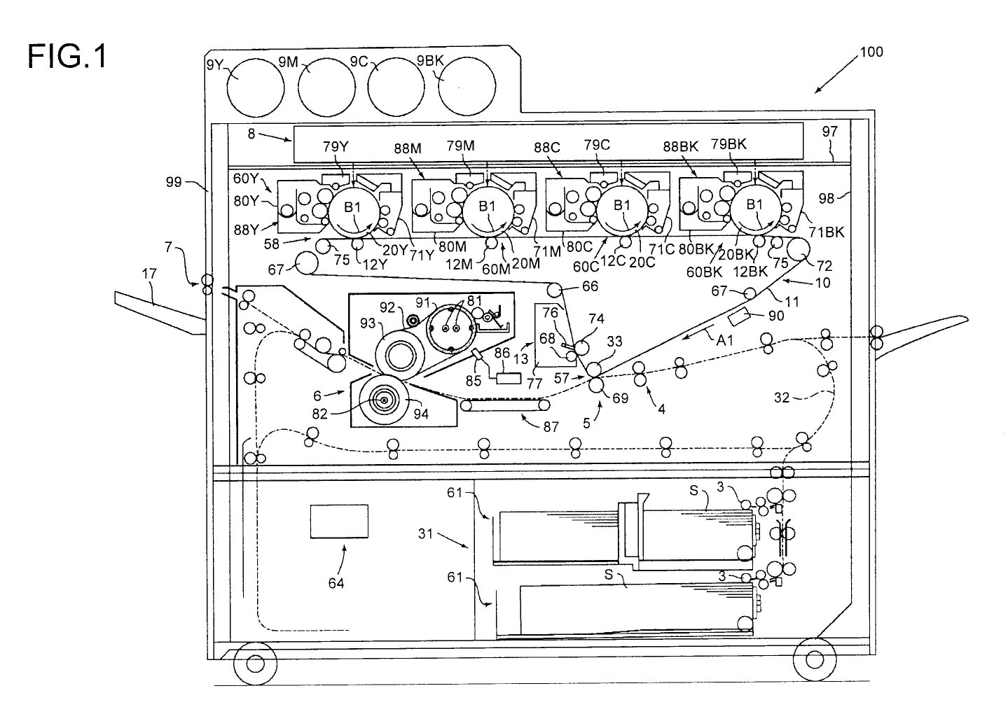

FIG. 1 is a schematic diagram of an image forming apparatus according to the embodiment of the present invention.

In FIG. 1, an image forming apparatus 100 is a color laser printer. However, the image forming apparatus 100 may be other image forming apparatuses such as a different type of printer, a facsimile, a copier, and an MFP of a copier and a printer. The image forming apparatus 100 performs image formation based on an image signal corresponding to image information externally received. The image forming apparatus 100 can generally form images using a sheet recording medium including an OHP sheet, a thick paper sheet such as a card and a postcard, and an envelope, for example, in addition to a plain paper sheet used for copying.

The image forming apparatus 100 adopts a tandem structure, in other words, a tandem system in which photosensitive drums 20Y, 20M, 20C, and 20BK are disposed in parallel with each other. The photosensitive drums 20Y, 20M, 20C, and 20BK are latent image carriers as first image carriers that can form images corresponding to colors separated into yellow, magenta, cyan, and black.

The photosensitive drums 20Y, 20M, 20C, and 20BK, which are surface moving members, are rotatably supported by a frame, not illustrated, of a main body 99 of the image forming apparatus 100, and are arranged in this order from the upstream side of a direction A1 that is the moving direction of a transfer belt 11 and is a clockwise direction in FIG. 1. The transfer belt 11 is an intermediate transfer body as a second image carrier. The signs Y, M, C, and BK added after the numerical characters of the reference numerals and signs express that the signs Y, M, C, and BK indicate members for yellow, magenta, cyan, and black.

The photosensitive drums 20Y, 20M, 20C, and 20BK are provided on image forming units 60Y, 60M, 60C, and 60BK, respectively, to form a yellow (Y) image, a magenta (M) image, a cyan (C) image, and a black (BK) image.

The photosensitive drums 20Y, 20M, 20C, and 20BK are positioned on the outer circumferential face side of the transfer belt 11 formed as an endless belt disposed in almost the center part in the main body 99, that is, positioned on the image forming face side.

The transfer belt 11 is movable in the direction of the arrow A1 while facing the photosensitive drums 20Y, 20M, 20C, and 20BK. Visible images, that is, toner images formed on the photosensitive drums 20Y, 20M, 20C, and 20BK are laid on and transferred to the transfer belt 11 traveling in the direction of the arrow A1, and then collectively transferred to a transfer paper sheet S that is a recording medium. Thus, the image forming apparatus 100 is an image forming apparatus according to an intermediate transfer method.

The upper portion of the transfer belt 11 is opposite to the photosensitive drums 20Y, 20M, 20C, and 20BK, and the opposing portion forms a primary transfer portion 58 that toner images on the photosensitive drums 20Y, 20M, 20C, and 20BK are transferred to the transfer belt 11.

Images are laid and transferred to the transfer belt 11 as timing is shifted from the upstream side to the downstream side in the direction A1 by applying a voltage using primary transfer rollers 12Y, 12M, 12C, and 12BK as primary transfer devices disposed at locations opposite to the photosensitive drums 20Y, 20M, 20C, and 20BK as the transfer belt 11 is sandwiched, in such a way that toner images formed on the photosensitive drums 20Y, 20M, 20C, and 20BK are laid and transferred at the same position on the transfer belt 11 in the process that the transfer belt 11 travels in the direction A1.

The transfer belt 11 is formed in a multi-layer structure in which a base layer is formed of a material that is not stretched so much, a smooth material is covered on the surface of the base layer to form a coating layer, and the coating layer is laid on the base layer. For the material of the base layer, a fluorine resin, a PVD sheet, and a polyimide resin are named, for example. For the material of the coating layer, a fluorine resin is named, for example.

The image forming apparatus 100 includes, in the main body 99, the four image forming units 60Y, 60M, 60C, and 60BK, a transfer belt unit 10 that is an intermediate transfer unit as an intermediate transfer device that is disposed below and opposite to the photosensitive drums 20Y, 20M, 20C, and 20BK and that includes the transfer belt 11, a secondary transfer device 5 disposed opposite to the transfer belt 11 on the lower side of the transfer belt 11 in FIG. 1, and an optical scanning device 8 that corresponds to an exposing unit for use in an optical writer as a latent image forming unit. In these devices, the optical scanning device 8 is disposed above and opposite to the image forming units 60Y, 60M, 60C, and 60BK.

The image forming apparatus 100 also includes, in the main body 99, a sheet feeder 61 as a paper cassette in which a large number of transfer paper sheets S carried toward a secondary transfer portion 57 between the transfer belt 11 and the secondary transfer device 5, a registration roller pair 4 that feeds the recording sheet S transported from the sheet feeder 61 toward the secondary transfer portion 57 at a predetermined timing matched with the timing of forming toner images by the image forming units 60Y, 60M, 60C, and 60BK, and a sensor, not illustrated, which detects that the leading end of the transfer paper sheet S reaches the registration roller pair 4.

The image forming apparatus 100 also includes, in the main body 99, a fixing device 6 as a fixing unit according to a belt-fixing method to fix a toner image transferred to the transfer paper sheet S, a belt transport device 87 that transports the recording sheet S having passed through the secondary transfer portion 57 to the fixing device 6, a discharge roller 7 as an ejecting roller pair that is an ejecting roller to eject the fixed transfer paper sheet S out of the main body 99, a discharge tray 17 as a discharging unit on which the transfer paper sheets S ejected out of the main body 99 by the discharge roller 7 are stacked, and toner bottles 9Y, 9M, 9C, and 9BK disposed above the main body 99 and filled with yellow, cyan, magenta, and black image forming toners, that is, toners.

The image forming apparatus 100 also includes an optical scanning device support frame 97 that fixes the optical scanning device 8, a side plate 98 in a plate shape that positions and fixes the optical scanning device support frame 97, drive units, not illustrated, individually provided as corresponding to the photosensitive drums 20Y, 20M, 20C, and 20BK to rotate the photosensitive drums 20Y, 20M, 20C, and 20BK, and a control unit 64 that controls the overall operations of the image forming apparatus 100 and includes a CPU, a memory, and the like, not illustrated.

The transfer belt unit 10 includes, in addition to the transfer belt 11, the primary transfer rollers 12Y, 12M, 12C, and 12BK as primary transfer bias rollers, a drive roller 72 that is a drive member on which the transfer belt 11 is wound, a cleaning counter roller 74 as a tension roller, tension rollers 33, 66, 67, and 75 as support rollers that stretch the transfer belt 11 together with the drive roller 72 and the cleaning counter roller 74, and a cleaning device 13 disposed opposite to the transfer belt 11 as a belt cleaning device that is an intermediate transfer body cleaning device to clean the surface of the transfer belt 11.

The transfer belt unit 10 also includes a drive system, not illustrated, that rotates the drive roller 72, and a power supply and bias control unit as a bias applying unit, not illustrated, that applies a primary transfer bias to the primary transfer rollers 12Y, 12M, 12C, and 12BK.

The cleaning counter roller 74 and the tension rollers 33, 66, 67, and 75 are driven rollers that are rotated in association with the transfer belt 11 rotated by the drive roller 72. The primary transfer rollers 12Y, 12M, 12C, and 12BK individually form a primary transfer nip by pressing the transfer belt 11 from the back surface of the transfer belt 11 to the photosensitive drums 20Y, 20M, 20C, and 20BK. The primary transfer nip is formed at a portion between the tension rollers 75 of the transfer belt 11. The tension rollers 75 have a function of stabilizing the primary transfer nip.

At the primary transfer nips, a primary transfer field is formed between the photosensitive drums 20Y, 20M, 20C, and 20BK and the primary transfer rollers 12Y, 12M, 12C, and 12BK because of the influence of a primary transfer bias. Color toner images formed on the photosensitive drums 20Y, 20M, 20C, and 20BK are primary-transferred on the transfer belt 11 because of the influence of the primary transfer field and a nip pressure.

The tension roller 33 is contacted with the secondary transfer device 5 through the transfer belt 11 to form the secondary transfer portion 57. The tension roller 66 has a tension roller function as a pressing member to provide a predetermined tensile force suited for transfer to the transfer belt 11.

The cleaning device 13 includes a cleaning blade 76 disposed so as to contact the transfer belt 11 at a position opposite to the cleaning counter roller 74, a brush roller 68 disposed opposite to the transfer belt 11 facing the cleaning counter roller 74 on the upstream side of the cleaning blade 76 in the direction A1, and a case 77 that accommodates the cleaning blade 76 and the brush roller 68 in the inside of the case 77.

The cleaning device 13 scrapes and removes foreign substances such as remaining toner on the transfer belt 11 using the brush roller 68 and the cleaning blade 76 for cleaning the transfer belt 11.

The transfer belt 11 is rotated at a linear velocity of 450 mm/sec by the operation of the drive system. However, this linear velocity is adjusted so as to correspond to the system velocity of the image forming apparatus 100. The system linear velocity is set at 400 mm/sec or more and 1,700 mm/sec or less. As described above, the image forming apparatus 100 is a high-speed machine, and is a super high-speed machine whose system linear velocity is super high-speed system velocity among others of high-speed machines. Thus, the image forming apparatus 100 can form 70 sheets or more of images for one minute in the case of A4-size transfer paper sheets S longitudinally transported in the transport direction.

The sheet feeder 61 accommodates the transfer paper sheets S in the state of a bundle of a plurality of transfer paper sheets stacked, and disposed in a multi-stage below the optical scanning device 8 in the lower part of the main body 99. The sheet feeder 61 in a multi-stage forms a paper bank 31 on the bottom part of the main body 99.

The sheet feeder 61 includes a feeding roller 3 as a paper feeding roller pressed against the top face of a topmost transfer paper sheet S. The feeding roller 3 is rotated at a predetermined timing in the counterclockwise direction to feed the topmost transfer paper sheet S toward the registration roller pair 4.

The transfer paper sheet S delivered from the sheet feeder 61 reaches the registration roller pair 4 through the paper feeding passage 32, and is sandwiched between the rollers of the registration roller pair 4. After that, the registration roller pair 4 delivers the transfer paper sheet S toward the secondary transfer portion 57.

The secondary transfer device 5 is disposed opposite to the tension roller 33. The secondary transfer device 5 contacts a secondary transfer roller 69 with the transfer belt 11 to form a nip portion that is the secondary transfer portion 57. The transfer paper sheet S is passed through the secondary transfer portion 57 that is this nip portion to transfer toner images to the transfer paper sheet S on the transfer belt 11.

The fixing device 6 includes a heater lamp 81 that is a heating unit as a heat source, a heating roller 91 including the heater lamp 81 in the inside of the heating roller 91, an endless fixing belt 92 wound on the heating roller 91, a fixing roller 93 on which the fixing belt 92 is wound together with the heating roller 91 and an auxiliary roller 95 that is a tension the roller, a pressing roller 94 provided at a position opposite to the fixing roller 93 through the fixing belt 92 as a pressing member to press the fixing belt 92 between the fixing roller 93 and the pressing roller 94, and a heater lamp 82 disposed inside the pressing roller 94, which is a heating unit as a heat source.

In the fixing device 6 in this configuration, the transfer paper sheet S on which a toner image is carried is passed through a fixing portion that is a pressing portion between the fixing belt 92 and the pressing roller 94, so that the carried toner image is permanently fixed on the surface of the sheet by the action of heat and pressure. The configuration of the fixing device 6 will be described later in detail.

The optical scanning device 8 for use in the image forming apparatus 100 illustrated in FIG. 1 deflects and scans laser light that is a light beam according to image information externally inputted to the image forming apparatus 100, and applies the laser light to the photosensitive drums 20Y, 20M, 20C, and 20BK simultaneously. It is noted that in the case where the image forming apparatus 100 is a copier, an electrostatic latent image is formed in the optical scanning device 8, in which a document set on the exposure glass of a document reader provide on the copier, for example, is optically read triggered by pressing a copy switch, for example, to form image information, and laser light is applied to the photosensitive drums 20Y, 20M, 20C, and 20BK according to the image information for exposure. The exposing unit is not limited to one according to the system of the optical scanning device 8. Such a configuration may be possible in which an array of LEDs is used, and the LEDs are arranged along a main-scanning direction vertical to FIG. 1 that is the longitudinal direction of the photosensitive drums 20Y, 20M, 20C, and 20BK.

Yellow, cyan, magenta, and black toners in the toner bottles 9Y, 9M, 9C, and 9BK are polymerized toners, and are refilled in the developing units 80Y, 80M, 80C, and 80BK provided on the image forming units 60Y, 60M, 60C, and 60BK by a predetermined amount of toner refilled through a transport passage, not illustrated.

The configurations of the image forming units 60BK, 60Y, 60M, and 60C will be described as the configuration of the image forming unit 60Y, one of the image forming units, provided with the photosensitive drum 20Y is as a representative one. It is noted that since the configurations of the other image forming units are substantially the same, in the following description, reference numerals and signs corresponding to the reference numerals and signs designated the configuration of the image forming unit 60BK are designated the configurations of the other image forming units for convenience, the detailed description is appropriately omitted. The reference numerals and signs having BK, Y, M, and C on the tails express the configurations of forming black, yellow, magenta, and cyan images.

The image forming unit 60Y includes the primary transfer roller 12Y, a cleaning device 71Y as a cleaning unit, a neutralization device, not illustrated, as an antistatic unit, a charging device 79Y as a charging unit for AC charging, and a developing unit 80Y as a developing unit for development using a two-component developer that is an image forming developer, around the photosensitive drum 20Y in a rotation direction B1 of the photosensitive drum 20Y, which is a counterclockwise direction in FIG. 1.

The photosensitive drum 20Y is driven by the drive unit and rotated in the direction B1 at a predetermined circumferential velocity. The cleaning device 71Y includes an elastic rubber blade that is a cleaning blade, not illustrated, to contact the photosensitive drum 20Y in the counter direction. The cleaning device 71Y scrapes and removes toner remaining on the photosensitive drum 20Y off the photosensitive drum 20Y for cleaning the photosensitive drum 20Y using the cleaning blade after primary transfer by the primary transfer roller 12Y.

The neutralization device includes an antistatic lamp that removes electric charges remaining on the surface of the photosensitive drum 20Y, which is cleaned by the cleaning device 71Y, and initializes the surface potential of the photosensitive drum 20Y.

The charging device 79Y includes a roller charging device as a charging member, not illustrated, that contacts the photosensitive drum 20Y. The roller charging device uniformly charges the surface of the photosensitive drum 20Y neutralized by the neutralization device.

The cleaning device 71Y includes the elastic rubber blade and the charging device 79Y includes the roller charging device, so that the photosensitive drum 20Y is excellently cleaned and charged.

The developing unit 80Y includes a developing roller, not illustrated, opposite to the photosensitive drum 20Y, in which in a development region in which toner included in developers carried on the developing roller are supplied to the photosensitive drum 20Y, the toner is attached only to an image forming portion between a non-imaging portion and the image forming portion both forming an electrostatic latent image formed by the optical scanning device 8, the electrostatic latent image is developed and visualized, and a toner image is formed on the surface of the photosensitive drum 20Y.

The detail of the toner used in the developing unit 80Y, in other words, the detail of the toner used in the image forming apparatus 100 will be described later.

The photosensitive drum 20Y, the cleaning device 71Y, the neutralization device, the charging device 79Y, and the developing unit 80Y configure a process cartridge 88Y detachable to the main body 99. The process cartridge formed in this manner is significantly preferable because the process cartridge can be handled as a replacement part, and maintenance is significantly improved. It is noted that, preferably, the process cartridge is configured to include at least the developing unit 80Y among the photosensitive drum 20Y, the cleaning device 71Y, the neutralization device, the charging device 79Y, and the developing unit 80Y because carriers included in a two-component developer are replaced in the replacement of the developing unit 80Y, for example.

In the image forming apparatus 100 with a configuration like this, when a signal instructing that a color image is formed is inputted, the drive roller 72 is driven to rotate the transfer belt 11, the cleaning counter roller 74, and the tension rollers 33, 66, 67, and 75, and the photosensitive drums 20Y, 20M, 20C, and 20BK are rotated in the direction B1.

The surfaces of the photosensitive drums 20Y, 20M, 20C, and 20BK are uniformly charged by the charging devices 79Y, 79M, 79C, and 79BK, respectively, in association with the rotation in the direction B1, and the optical scanning device 8 scans laser light for exposure to form electrostatic latent images corresponding to yellow, magenta, cyan, and black. The developing units 80Y, 80M, 80C, and 80BK develop the electrostatic latent images using yellow, magenta, cyan, and black toners, and a monochrome image formed of yellow, magenta, cyan, and black toner images is formed.

The yellow, magenta, cyan, and black toner images obtained by development are in turn laid and transferred at the same position on the transfer belt 11 rotating in the direction A1 with the primary transfer rollers 12Y, 12M, 12C, and 12BK, and a composite color image is formed on the transfer belt 11.

On the other hand, in the case where a signal instructing that a color image is formed is inputted, or in the case where the image forming apparatus 100 is a copier, any one of the paper banks 31 provided on the sheet feeder 61 is selected in association with the pressing down the copy switch, the feeding roller 3 provided on the selected sheet feeder 61 is rotated to feed the transfer paper sheets S and to separate and deliver the transfer paper sheets S one by one to the paper feeding passage 32, the transfer paper sheet S delivered to the paper feeding passage 32 is further transported by a carriage roller, not illustrated, and the transfer paper sheet S stops as the transfer paper sheet S bumps against the registration roller pair 4.

The registration roller pair 4 is rotated at the timing at which the composite color image laid on the transfer belt 11 is moved to the secondary transfer portion 57 in association with the rotation of the transfer belt 11 in the direction A1. The composite color image closely contacts the transfer paper sheet S delivered to the secondary transfer portion 57 in the secondary transfer portion 57, and the composite color image is secondary-transferred to the transfer paper sheet S by the action of a bias formed by a nip pressure and the power supply for recording.

The transfer paper sheet S is delivered to the fixing device 6 by the belt transport device 87, and the carried toner image, that is, the composite color image is fixed to the transfer paper sheet S by the action of heat and pressure when the transfer paper sheet S passes through the fixing portion between the fixing belt 92 and the pressing roller 94 at the fixing device 6. The fixing is excellently performed as described later.

The transfer paper sheet S having passed through the fixing device 6 on which the composite color image is fixed passes through the discharge roller 7, and ejected out of the main body 99, and stacked on the discharge tray 17 in the upper part of the main body 99.

Remaining toner after transferred on the photosensitive drums 20Y, 20M, 20C, and 20BK are removed using the cleaning devices 71Y, 71M, 71C, and 71BK, and the photosensitive drums 20Y, 20M, 20C, and 20BK are neutralized by the neutralization device, and are subsequently charged by the charging devices 79Y, 79M, 79C, and 79BK.

The surface of the transfer belt 11 after secondary transfer and after passing through the secondary transfer portion 57 is cleaned by the cleaning device 13 provided on the cleaning blade 76, and the transfer belt 11 is prepared for subsequent transfer.

The image forming operation in the image forming apparatus 100 is performed as described above. Since the image forming apparatus 100 is a high-speed machine to perform the image formation at a system velocity of 400 mm/sec or more and 1,700 mm/sec or less, it is necessary to avoid the foregoing gloss unevenness sufficiently enough.

One of factors to avoid gloss unevenness is the quantity of heat applied to toner.

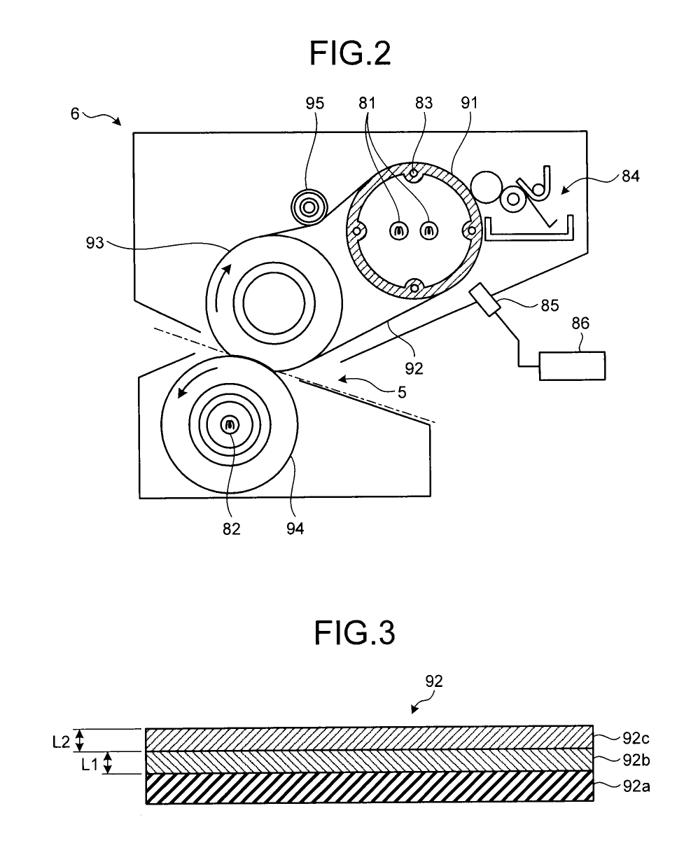

In the embodiment, a configuration illustrated in FIG. 2 is used as a fixing device that supplies heat affecting gloss unevenness.

In FIG. 2, the fixing device 6 includes a heat pipe 83 integrally formed with the heating roller 91, an oil coating mechanism 84 that applies oil as a release agent to the fixing belt 92 at a position at which the fixing belt 92 is wound on the heating roller 91, a thermopile 85 disposed opposite to the fixing belt 92 at the position at which the fixing belt 92 is wound on the heating roller 91, a temperature detecting unit 86 connected to the thermopile 85 to detect the surface temperature of the fixing belt 92, and a drive unit, not illustrated, that rotates the fixing roller 93 to rotate the fixing belt 92, the heating roller 91, the auxiliary roller 95, and the pressing roller 94.

The heating roller 91 is heated by the heater lamp 81 and heats the fixing belt 92 from the inner side.

The auxiliary roller 95 is disposed so as to come into contact with the outer circumferential surface of the fixing belt 92 such that the auxiliary roller 95 is offset to the fixing belt 92, and the auxiliary roller 95 stretches the fixing belt 92.

The pressing member may be in a belt shape, not in a roller shape like the pressing roller 94 as long as the pressing member is a rotating member.

The fixing roller 93 and the fixing belt 92 are referred to as a fixing member individually or by a general term.

The fixing belt 92 includes a meandering-proof rib, not illustrated, at both ends thereof for preventing meandering in rotation. The fixing belt 92 is rotated by the drive unit through the fixing roller 93, and the fixing belt 92 is rotated at a linear velocity of 450 mm/sec. However, the linear velocity is appropriately adjusted to as to correspond to the system velocity of the image forming apparatus 100.

In the adjustment, the drive of the heater lamp 81 is controlled based on the temperature detected at the temperature detecting unit 86. Since the thermopile 85 is disposed at a position opposite to the heating roller 91 through the fixing belt 92, the temperature detecting unit 86 is substantially disposed at this position, and detects the surface temperature of the fixing belt 92 at this position. Since the temperature detecting unit 86 detects the temperature at this position, the surface temperature of the fixing belt 92 is excellently detected. It is noted that as long as the temperature detecting unit is disposed at least at this position, another temperature detecting unit can be disposed at other positions.

FIG. 3 is the configuration of the fixing belt 92 for use in the fixing device 6.

In FIG. 3, the fixing belt 92 at least includes a base layer 92a, a rubber layer 92b, and a releasing layer 92c. A thickness L1 of the rubber layer 92b is 400 μm or more and 750 μm or less. A thickness L2 of the releasing layer 92c is 2 μm or more and 20 μm or less. The toner used in image formation has a composition and characteristics described later.

For the material of the base layer 92a, a material excellent in heat-resisting properties is selected from resins such as polyimide resin or metals such as nickel.

The material of the rubber layer 92b is selected from materials different from the material of the base layer 92a and having a large heat capacity and a large amount of heat transport, and the material of the rubber layer 92b functions as a thermal storage layer (i.e., an elastic layer). More specifically, rubber materials are suited for the material of the rubber layer 92b, and preferably, silicone rubber in particular.

Since the releasing layer 92c forms the topmost surface of the fixing belt 92 and is used as a fixing surface that comes into contact with the toner, releasing characteristics are particularly considered to be important. Therefore, the releasing layer 92c is formed of a fluorine material significantly useful to secure the releasing characteristics. In the embodiment, the releasing layer 92c is formed of a fluorine resin, more specifically a PFA to form a fluorine resin layer.

In the fixing device 6, in order to improve the releasing characteristics, the oil coating mechanism 84 is provided to apply oil as a release agent to the surface of the fixing belt 92. Because of this point, when the releasing layer 92c which is the topmost layer is formed of a material different from a fluorine resin, oil is not smoothly applied, and the effect of oil is not exerted enough. However, since the releasing layer 92c is formed of PFA that is a fluorine resin, the releasing layer 92c works out well with oil, the releasing characteristics are sufficiently exerted.

The following conditions are set to the layer thickness L1 of the rubber layer 92b and the layer thickness L2 of the releasing layer 92c for use in the fixing belt 92.

Since importance is placed on a thermal storage function for the rubber layer 92b, it has been found that preferably, the layer thickness L1 is in a range of 400≦L1≦750 μm. This is because the thermal storage effect is not obtained enough when the layer thickness L1 is smaller than 400 μm, the quantity of heat applied to the toner is prone to be insufficient to tend to cause gloss unevenness, whereas when the layer thickness L1 is greater than 750 μm, thermal inertia becomes large to degrade the start-up characteristics.

Since importance is placed on the releasing characteristics for the releasing layer 92c, the layer thickness L2 serves the function sufficiently even though the layer thickness L2 is smaller than the layer thickness L1. It has been found that preferably, the layer thickness L2 is in a range of 2≦L2≦20 μm. This is because durability becomes insufficient when the layer thickness L2 is smaller than 2 μm, whereas when the layer thickness L2 is greater than 20 μm, a problem arises in the amount of heat transport, and gloss unevenness is prone to occur.

It is noted that in the example illustrated in FIG. 3, the rubber layer 92b is laid on the base layer 92a, and the releasing layer 92c is laid on the rubber layer 92b. Such a configuration may be accepted in which other layers are provided between the base layer 92a, the rubber layer 92b, and the releasing layer 92c, as long as the functions of these layers are exerted enough. Moreover, the thicknesses of the base layer 92a, the rubber layer 92b, and the releasing layer 92c illustrated in FIG. 3 and the ratios between the thicknesses are not necessary matched with the actual ones.

The foregoing fixing device 6 contributes to providing an inexpensive image forming apparatus that stably outputs fixing image quality without upsizing and complicating the fixing device 6 and the image forming apparatus 100.

In the following, toner which is used for image formation in the image forming apparatus 100 and to which the present invention is applied will be described.

First, a basic configuration of such toner will be described.

The toner at least includes a release agent and a binder resin.

The release agent at least includes a microcrystalline wax.

The binder resin at least includes a crystalline polyester resin and an amorphous polyester resin. A resin peak ratio W/R of a height W of the third falling peak of an infrared absorption spectrum of the crystalline polyester resin to a height R of the maximum rising peak of an infrared absorption spectrum of the amorphous polyester resin, which are measured by an infrared spectroscopy (a KBr pellet method) using Fourier transform infrared spectrometer, is 0.045 or more and 0.850 or less.

More specifically, in the case where the peak height of a characteristic absorbance spectrum of a crystalline polyester resin is W, and the peak height of a characteristic absorbance spectrum of an amorphous resin is R, which are measured by a KBr method (a total transmission method) using Avatar 370, which is an FT-IR (Fourier transform infrared spectrometer) made by ThermoElectron Corporation, an amount of a crystalline polyester resin localized on the toner surface, that is, the crystalline polyester resin content is in that the resin peak ratio W/R is 0.045 or more and 0.850 or less, more preferably, 0.080 or more and 0.450 or less.

It is important that the resin peak ratio W/R is 0.045 or more and 0.850 or less. In the case where the peak ratio is less than 0.045, a wax is not easily exuded from the inside of a toner particle in fixing, the releasing characteristics from the image surface are inferior, and gloss unevenness on the image surface is degraded. In the case where the peak ratio is greater than 0.850, a wax is exuded from the toner surface too much, the wax contaminates a paper carriage roller or the like in the apparatus, parts lifetime is impaired, and problems arise.

Although a mechanism of easy exudation of a wax by a crystalline polyester is not revealed, the following is assumed.

Namely, a specific crystalline polyester is not compatible with an amorphous resin in a toner base particle, and dispersed in the toner base particle in a crystalline state. It is considered that a specific wax defined by the present invention has an affinity with a crystalline polyester resin and tends to come close to the crystalline polyester resin, the wax is dispersed together with the crystalline polyester resin dispersed, and the crystalline polyester resin serves as a dispersing agent for the wax in a sense. Therefore, it is assumed that the wax uniformly dispersed is easily exuded to the toner surface with energy of heat and a pressure in fixing, and the releasing effect acts to improve image surface roughness and gloss unevenness.

Because of the total effect of the toner, which includes a crystalline polyester resin and uses a microcrystalline wax particularly as a release agent wax, and the fixing mechanism using the elastic fixing belt defined as described above, image surface roughness and gloss unevenness are first improved in an image forming apparatus operated at super high speed system linear velocity like the image forming apparatus 100.

It is considered that control on the resin peak ratio W/R is determined by a compatible state between a crystalline polyester resin and an amorphous resin. However, since it is difficult to measure a degree of crystallinity, in the present invention, the manufacturing conditions such as the manufacturing process steps including a ratio of toner formula raw materials and emulsification are optimized by schemes of quality engineering, and the formula and the manufacturing conditions are optimized for the optimum conditions in such a way that the resin peak ratio W/R falls in a range of 0.045 to 0.850, so that the resin peak ratio is intentionally and reliably achieved. In other words, the technical key point according to the present invention also resides in that the optimum conditions for the formula and manufacture are found so as to control the compatible state between a crystalline polyester resin and an amorphous resin in consideration of the balance of quality problems.

Measurement Method for Resin Peak Ratio W/R

Resin peak ratio of the toner surface is obtained by a peak intensity ratio observed in a KBr spectrum according to a KBr method (a total transmission method) using an FT-IR (Fourier transform infrared spectrometer).

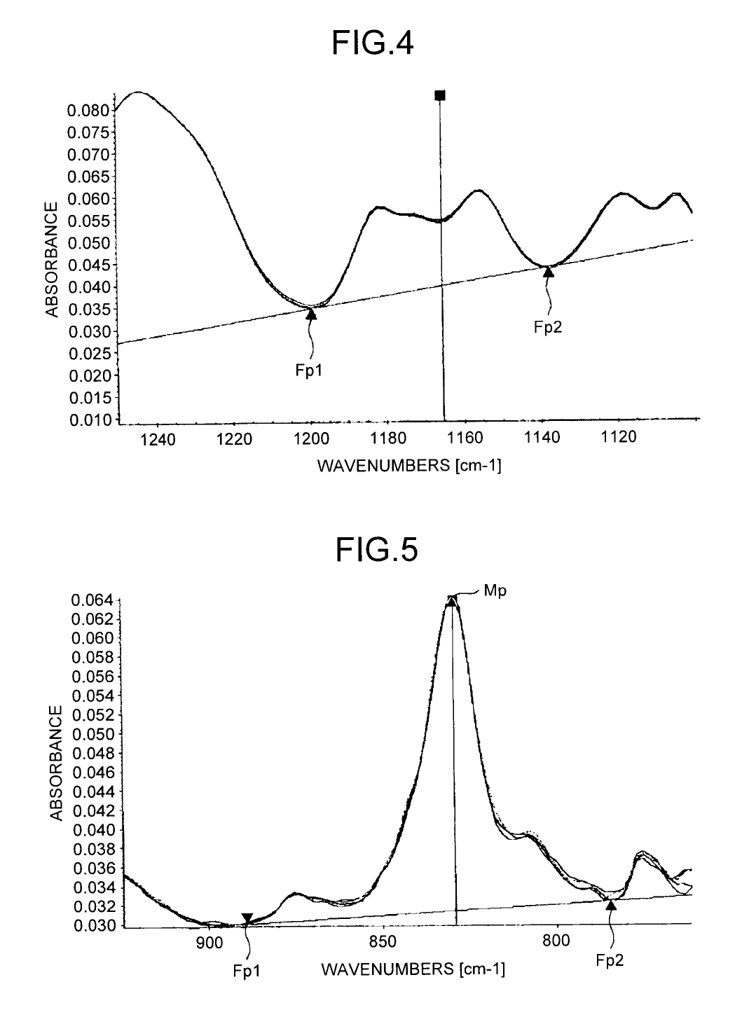

More specifically, the ratio W/R was calculated as a peak intensity ratio where the peak height of a characteristic spectrum (1,165 cm⁻¹) when a crystalline polyester resin is in a crystalline state is W (as illustrated in FIG. 3, the base line of the height ranges from 1,199 to 1,137 cm⁻¹, and the detail in FIG. 3 will be described later), and the peak height of a characteristic spectrum of an amorphous resin (829 cm⁻¹ in the case of a polyester resin, for example) is R (as illustrated in FIG. 4, the base line of the height ranges from 784 to 889 cm⁻¹, and the detail in FIG. 3 will be described later). For the peak intensity ratio, the spectrum was calculated into an absorbance, and the peak height of the absorbance was used.

Meanwhile, it is important that the content of inorganic fine particles is from 0.80 to 5.00 parts per 100 parts of a toner base particle. In other words, in the case where the content of inorganic fine particles is 0.80 part or less, the cohesiveness and storage life of the toner is degraded, whereas in the case where the content is 5.00 parts or more, the total coverage factor of an additive is too high on the toner surface, so that the wax is not easily exuded from the inside of the toner in fixing. Thus, the foregoing conditions are set because it was revealed that the releasing characteristics from the image surface are inferior and gloss unevenness occurs on the image surface.

Moreover, it is preferable to use a microcrystalline wax having the following characteristic for a release agent included in a toner particle. This will be described below more specifically.

In the case of using a microcrystalline wax, it is preferable to use a microcrystalline wax having the following characteristics.

(1) A microcrystalline wax is formed of a hydrocarbon having a carbon number of 20 or more and 80 or less and the straight-chain hydrocarbon content of the hydrocarbon is 55 percent by weight or more and 70 percent by weight or less.

(2) The melting point defined by the maximum heat absorption peak temperature according to differential scanning calorimetry (DSC) is 65° C. or more and 90° C. or less.

The reason why such conditions are given is that in the case where the carbon number is smaller than 20, or in the case where the melting point according to DSC is smaller than a temperature of 65° C., a wax is exuded from the toner surface too much in fixing, the wax contaminates a paper carriage roller or the like in the apparatus, parts lifetime is impaired, and problems arise. Moreover, in the case where the carbon number is greater than 80, or in the case where the melting point according to DSC is greater than a temperature of 90° C., a wax is not easily exuded from the inside of a toner particle in fixing, the releasing characteristics from the image surface are inferior, and gloss unevenness on the image surface is degraded.

Furthermore, preferably, the content (the weight ratio) of the release agent of the toner is 1% or more and 20% or less with respect to the total amount of toner base particles.

The reason why such conditions are given is that in the case where the content is 1% or less, the wax is insufficiently exuded from the inside of the toner in fixing, the releasing characteristics from the image surface are inferior, and gloss unevenness on the image surface is degraded. In addition, in the case where the content is 20% or more, a wax is exuded from the toner surface too much in fixing, the wax contaminates a paper carriage roller or the like in the apparatus, parts lifetime is impaired, and problems arise.

Moreover, preferably, the heat absorption peak temperature of a crystalline polyester resin measured according to differential scanning calorimetry (DSC) is 50° C. or more and 150° C. or less.

The reason why the conditions is that in the case where the peak temperature is 50° C. or less, the heat storage life of toner is degraded, the toner becomes solid in the process of storage, and flowability becomes inferior. Furthermore, in the case where the peak temperature is 150° C. or more, a wax is not easily exuded from the inside of a toner particle in fixing, the releasing characteristics from the image surface are inferior, and gloss unevenness on the image surface is degraded.

In addition, preferably, the volume average particle diameter of the toner base particle is 3.0 μm or more and less than 6.0 μm. In the case where the volume average particle diameter is less than 3.0 μm, a development sleeve is prone to be fastened because there are too many fine particles, whereas in the case where the volume average particle diameter is 6.0 μm or more, it can be prevented that the total surface area of a toner particle is reduced, a wax is not easily exuded from the inside of a toner particle, the releasing characteristics from the image surface are inferior, and gloss unevenness on the image surface is degraded.

Moreover, preferably, a particle diameter ratio which is a value that the volume average particle diameter of the toner base particle of the toner is divided by a number average particle diameter is 1.05 or more and 1.25 or less. This is because in the case where the particle diameter ratio is less than 1.05, it is demanded to eliminate a considerable amount of fine particles in order to make an even toner dispersion, and productivity is seriously degraded. Furthermore, in the case where the particle diameter ratio is 1.25 or more, the particle diameter distribution becomes to wide, it is difficult to uniformly exude a wax to the toner surface, the releasing characteristics from the image surface are inferior, and gloss unevenness on the image surface is degraded.

In addition, preferably, toner is manufactured by a manufacturing method including the steps of: putting at least a binder resin, a binder resin precursor, or a binder resin and a binder resin precursor, and a release accelerator into an organic solvent to prepare an toner solution; putting the toner solution into an aqueous medium to obtain an emulsion or a dispersion; and forming the toner base particles while removing the solvent from the emulsion or the dispersion.

This is because the dispersion effect of C-Pes and a wax is further improved by the polymerization method, and the wax can be uniformly dispersed in the inside of the toner, so that it is avoided that a wax is not easily exuded from the inside of a toner particle in fixing, the releasing characteristics from the image surface are inferior, and gloss unevenness on the image surface is degraded.

Moreover, as described above, it is important for the fixing belt 92 for use in the fixing device 6 to include the heating roller 91 on which the fixing belt 92 is wound and which includes the heating unit inside the heating roller 91, the fixing roller 93 on which the fixing belt 92 is wound, the pressing roller 94 provided at a position opposite to the fixing roller 93 through the fixing belt 92, and the temperature detecting unit 86 that detects the surface temperature of the fixing belt 92. Thus, the temperature is appropriately detected to efficiently transmit the quantity of heat to a toner image, so that it can be prevented that a wax is not easily exuded from the inside of a toner particle in fixing, the releasing characteristics from the image surface are inferior, and gloss unevenness on the image surface is degraded.

Furthermore, preferably, the temperature detecting unit used for detecting the temperature of the fixing belt is disposed at least one location at a position opposite to the heating roller on the fixing belt. Thus, the accuracy of detecting the temperature is improved, and the foregoing effect can be more effectively obtained.

In addition, in the present invention, preferably, toner is manufactured according to a polymerization method including the steps of: dissolving or dispersing toner materials in an organic solvent to prepare a toner material solution (in an oil phase); and emulsifying or dispersing the oil phase in an aqueous medium (in an aqueous phase) and removing the solvent to form toner base particles.

The reason is as follows.

One of important effects of the present invention is in that a release agent is easily exuded from the inside of a toner particle to the outer face in fixing. One of the premises is that it is essential to uniformly disperse a crystalline polyester resin and a release agent in the inside of the toner as much as possible. Also, it is confirmed that the material dispersibility of the toner particle formed by according to the foregoing polymerization method using a grinding method is significantly excellent in uniformity, so that the foregoing effect can be made greater.

In the following, raw materials (toner materials) of the toner for use in the image forming apparatus will be in turn described.

(Release Agent)

For a release agent used for toner materials of the toner including the toner base particles according to the present invention, it is important that the material is a microcrystalline wax, for example.

The microcrystalline wax for use in the toner is formed of a hydrocarbon having a carbon number ranging from 20 to 80. Preferably, the average carbon number is in a range of 50±20. When the average carbon number is small, the releasing characteristics become excellent at low temperatures, whereas when the average carbon number is large, anti-cohesiveness and anti-filming characteristics are further improved. When the average carbon number is less than 20, the penetration of the wax is large, the wax is softened to cause the agglomeration of toner particles, and filming is prone to occur on the photosensitive drum, the fixing roller, the fixing film, or the like. Moreover, in the case where the average carbon number exceeds 80, wax dispersion that the present invention desires is not achieved, and it is not enabled to prevent contamination caused by the wax.

The carbon number and average carbon number of the release agent of the toner are measured according to high-temperature gel permeation chromatography (high temperature GPC).

The carbon number means a value that a molecular weight when starting the flow of a chromatogram measured by high temperature GPC is divided by a molecular weight of 14 of a methylene group and a value that a molecular weight when ending the flow of the chromatogram is divided by a molecular weight of 14 of a methylene group, and expresses the dispersion of carbons forming a hydrocarbon. Moreover, the average carbon number means a value that a peak molecular weight of a chromatogram measured by high temperature GPC is divided by a molecular weight of 14 of a methylene group.

More specifically, a molecular weight is measured as follows. O-dichlorobenzene added with 0.1% of ionol is used as a solvent, and flowed under the temperature conditions at a temperature of 135° C., molecules are detected using a differential refractometer detector, and a molecular weight is found by the absolute molecular weight conversion of polyethylene according to universal calibration.

The content ratio of a straight-chain hydrocarbon is measured by gas chromatography. A mixture of a straight-chain hydrocarbon and a non-straight-chain hydrocarbon is separated in moving in a stationary phase with a carrier gas because the rates of travel are different due to a difference in adsorption from the stationary phase or in dispersion. The content of the straight-chain hydrocarbon is calculated from the ratio between peak holding time and a peak area appearing in a gas chromatogram.

A packed column or a capillary column is used for a separation column. For the packed column, such columns are used in which an adsorptive material such as activated carbon, activated alumina, silica gel, porous spherical silica, a molecular sieve, and mineral salts is used for a filler, or paraffin oil, silicone oils, or the like coated in a thin film on the surface of a fine particle such as diatomite, firebrick powder, a glass silica bead, a fused silica bead, and graphite is used for a filler. The capillary column uses no filler, and the paraffin oil, silicone oils, or the like are coated for use. For the carrier gas, nitrogen, helium, hydrogen, or argon is used.

For the detector, a heat radiation thermal conductivity detector, an aerometer, an ionization cross section detector, or an ionization detector (hydrogen flames, β rays, electron capture waves, or radio frequency waves) is used.

The hydrocarbon according to the present invention is separated and purified from a vacuum distillation residual oil or a heavy distillate oil of petroleum, and is further split by high temperature GPC, and a desired hydrocarbon can be obtained.

The melting point of the release agent according to the present invention is the temperature of a heat absorption peak at which the quantity of heat absorbed becomes the maximum in differential thermal curves obtained by differential scanning calorimetry (DSC) (referred to as “the maximum heat absorption peak temperature”).

(Crystalline Polyester)

As described above, as a binder resin of the toner base particle configuring the toner according to the present invention, a crystalline polyester (in the following, crystalline polyester (iii)) is included.

Crystalline polyester (iii) is obtained by a reaction between an alcohol component and an acid component, which is a polyester having at least a melting point.

For the alcohol component of crystalline polyester (iii), a diol compound having a carbon number of 2 to 6, particularly, 1,4-butanediol, 1,6-hexanediol, and derivatives of the compounds are included. Moreover, for the acid component, preferably, at least one of maleic acid, fumaric acid, succinic acid, and derivatives of these acids is included. Namely, such a crystalline polyester is preferable, which is synthesized from the alcohol component and the acid component and has a repetitive structure unit expressed by a general formula (I) below.

O—CO—CR₁═CR₂—CO—O—(CR₂)₀ (1)

In the general formula (I), R1 and R2 are a hydrogen atom or a hydrocarbon radical, the carbon number ranges from 1 to 20, and n is a natural number.

Moreover, for a method of controlling the crystallizability and softening point of crystalline polyester (iii), such a method is named, for example, in which the molecules of a non-linear polyester or the like are appropriately designed and used. These non-linear polyesters can be synthesized in which an alcohol component is added with a polyalcohol of a trivalent alcohol or more such as glycerin or an acid component is added with a polycarboxylic acid of a trivalent carboxylic acid or more such as trimellitic anhydrid for condensation polymerization in the synthesization of a polyester.

The molecular structure of crystalline polyester (iii) can be confirmed by solid NMR or the like.

For the molecular weight, as a result of an ardent investigation from the viewpoint that one having a sharp molecular weight distribution and a low molecular weight exhibits an excellent low-temperature fixity, it was found that such a molecular weight is preferable in which in the molecular weight distribution of o-dichlorobenzene by GPC for a soluble portion, a peak position is in a range of 3. 5 to 4.0, a peak half width is 1.5 or less, a weight average molecular weight (Mw) is in a range of 1,000 to 6,500, a number average molecular weight (Mn) is in a range of 500 to 2,000, and Mw/Mn is in a range of 2 to 5 in a molecular weight distribution map in which the horizontal axis expresses log (M) and the vertical axis expresses percent by weight.

Preferably, the dispersed particle diameter of the toner base particle of crystalline polyester (iii) for use in the toner material according to the present invention is 0.2 μm or more and 3.0 μm or less (0.2 to 3.0 μm) in the major axis diameter.

The major axis diameter of the dispersed particle diameter is controlled within a range of 0.2 to 3.0 μm, so that the dispersion of a specific microcrystalline wax can be made more reliable in the toner base particle, and the uneven distribution of wax can be suppressed on the surface of the toner base particle.

Preferably, the acid value of crystalline polyester (iii) is 8 mgKOH/g or more and 45 mgKOH/g or less. Namely, from the viewpoint of an affinity between a paper sheet and a resin, in order to achieve a targeted low-temperature fixity, preferably, the acid value is 8 mgKOH/g or more, more preferably, 20 mgKOH/g or more. On the other hand, in order to improve hot offset characteristics, preferably, the acid value is 45 mgKOH/g or less.

Moreover, for the hydroxyl value of crystalline polyester, in order to achieve a predetermined low-temperature fixity and excellent charging characteristics, preferably, the acid value is 0 mgKOH/g or more and 50 mgKOH/g or less (0 to 50 mgKOH/g), more preferably, 5 to 50 mgKOH/g.

For the coloring agent, publicly known dyes and pigments are used, including, for example, carbon black, nigrosine dyes, iron black, naphthol yellow S, hansa yellow (10G, 5G, G), cadmium yellow, yellow oxidize, ocher, chrome yellow, titanium yellow, polyazo yellow, the oil yellow, hansa yellow (GR, A, RN, R), pigment yellow L, benzidine yellow (G, GR), permanent yellow (NCG), vulcan fast yellow (5G, R), tartrazine lake, quinoline yellow lake, ansrazan yellow BGL, isoindolinone yellow, colcothar, red lead, vermilion lead, cadmium red, cadmium mercury red, antimony vermilion, permanent red4R, para red, phase red, parachloro-o-Nitroaniline red, lithol fast scarlet G, brilliant fast scarlet, brilliant carmine BS, permanent red (F 2R, F4R, FRL, FRLL, F4RH), fast scarlet VD, vulcan fast rubine B, brilliant scarlet G, lithol rubine GX, permanent redF5R, brilliant carmine 6B, pigment scarlet 3B, bordeaux 5B, toluidine maroon, permanent bordeaux F2K, helio bordeaux BL, bordeaux 10B, BON maroon light, BON maroon medium, eosine lake, rhodamine lakeB, rhodamine lake Y, alizarin lake, thioindigo redB, thioindigo maroon, oil red, quinacridon red, pyrazolone red, polyazo red, molybdate orange, benzidine orange, perinone orange, the oil orange, cobalt blue, cerulean blue, alkali blue lake, peacock blue lake, victoria blue lake, organic phthalocyanine blue, phthalocyanine blue, fast sky blue, indanthrene blue (RS, BC), indigo, ultramarine blue, Prussian blue, anthraquinone blue, fast violet B, methylvioletlake, cobalt violet, manganese violet, dioxane violet, anthraquinone violet, chromium green, zinc green, chrome oxide, viridian, emerald green, pigment green B, naphthol green B, green gold, acid green lake, malachite green lake, phthalocyanine green, anthraquinone green, titanium oxide, zinc white, lithopone, and mixtures of them. The content of the coloring agent is generally 1 to 15 percent by weight with respect to the toner. Preferably, the content is 3 to 10 percent by weight.

It is noted that the toner may include a charging control agent as necessary. Known agents can be used for such a charging control agent, including, for example, nigrosine dyes, triphenylmethane dyes, chromium containing metal complex dyes, molybdic acid chelate pigments, rhodamine dyes, alkoxyamine, quaternary ammonium salts (including fluorine-modified quaternary ammonium salts), alkylamide, phosphorus simple substances or phosphorus compounds, tungsten simple substances or tungsten compounds, fluorine activators, salicylic acid metallic salts, and salicylic acid derivative metallic salts, or the like. More specifically, the charging control agent includes BONTRON 03 (nigrosine dyes), BONTRON P-51 (quaternary ammonium salts), BONTRON S-34 (metal azo dyes), E-82 (oxynaphthoic acid metal complexes), E-84 (salicylic acid metal complexes), and E-89 (phenol condensates) made by Orient Chemical Industries Co., Ltd., TP-302 and TP-415 (quaternary ammonium salt molybdenum complexes) made by Hodogaya Chemical Co., Ltd., COPYCHARGE PSYVP2038 (quaternary ammonium salts), COPY BLUE PR (triphenylmethane derivatives), and COPYCHARGE NEGV P2036 and COPYCHARGE NXVP434 (quaternary ammonium salts) made by Hoechst AG, LRA-901 and LR-147 (boron complexes) made by Japan Carlit Co., Ltd., copper phthalocyanine, perylene, quinacridon, and azo pigments, and polymer compounds having a functional group such as a sulfuric group, a carboxyl group, and quaternary ammonium salts.

The amount of the charge control agent used is determined according to a type of binder resin, the presence or absence of an additive for use as necessary, methods of manufacturing toner including dispersion methods, and so on. Although it is difficult to uniquely restricted, the charge control agent is generally used in a range of 0.1 to 10 parts by weight with respect to 100 parts by weight of a binder resin. Preferably, the used amount is in a range of 0.2 to 5 parts by weight. In the case where the used amount exceeds 10 parts by weight, the electrification characteristics of the toner is too large, so that the effect of a main charging control agent is degraded, and electrostatic attraction to the developing roller is increased, causing a reduction in the flowability of the developer and a reduction in image density. The charging control agents may be dissolved and dispersed after molten and kneaded together with a masterbatch and a resin, the charging control agents may be directly added when the charging control agents may be dissolved or dispersed in an organic solvent in the preparation step of a toner material solution (in an oil phase), or the charging control agents may be fixed on the surface of a toner base particle after forming the toner base particle.

The toner is configured of toner base particles formed such that the toner solution (in an oil phase) of a toner material is emulsified or dispersed in an aqueous medium (in an aqueous phase) to form a particle (a colored particle) granulated by desolvation. An additive may be added on the surface of the toner base particle to assist the flowability, development characteristics, electrification characteristics, and cleaning characteristics of the toner including the toner base particles. For the additive to assist the flowability, development characteristics, and electrification characteristics of the toner base particle, preferably, an inorganic fine particle is used. Preferably, the primary particle diameter of the inorganic fine particles is 5 μm to 2 μm, more particularly 5 mμ to 500 mμ. Moreover, preferably, the specific surface area of the toner including the toner base particle is 20 to 500 m²/g according to the BET method. Preferably, the use ratio of the inorganic fine particles is 0.01 to 5 percent by weight of the toner, more particularly, 0.01 to 2.0 percent by weight. Specific examples of the inorganic fine particle includes, for example, silica, alumina, titanium oxide, barium titanate, magnesium titanate, calcium titanate, strontium titanate, zinc oxidize, tin oxidize, silica sand, clay, mica, wollastonite, silious earth, chromium oxidize, cerium oxidize, colcothar, antimony trioxide, magnesium oxidize, zirconium dioxide, barium sulfate, barium carbonate, calcium carbonate, silicon carbide, silicon nitride, and so on. In addition to this, the inorganic fine particle may use polymer fine particles including polystyrenes, methacrylate esters, or acrylic ester copolymers obtained by soap-free emulsified polymerization, suspension polymerization, and dispersion polymerization, polycondensation systems such as silicone, benzoguanamine, and nylon, or a polymer particle made of a thermosetting resin, for example.

The toner particle may be subjected to surface treatment using a superplasticizer as necessary. Thus, hydrophobicity is improved, and the degradation of the flowability characteristics and the charging characteristics can be prevented even at high humidities. For example, the following is named as preferable surface treatments such as a silane coupling agent, a sililation reagent, a silane coupling agent including alkyl fluoride, an organic titanate coupling agent, an aluminum coupling agent, silicone oils, and modified silicone oils.

The toner according to the embodiment is manufactured by process steps of: dissolving or dispersing at least a binder resin, a binder resin precursor, or a material including a binder resin and a binder resin precursor in an organic solvent to prepare a toner material solution (in an oil phase); and emulsifying or dispersing the toner solution in an aqueous medium (in an aqueous phase) and removing the solvent to form toner base particles. In the following, an exemplary method of manufacturing will be described. However, a method of manufacturing the toner according to the present invention is not limited to the example.

For the binder resin, a modified polyester including at least an ester bond and a bond unit other than an ester bond is used. The binder resin precursor is a resin precursor that can generate the modified polyester. Preferably, the binder resin precursor includes a polyester having a compound including an active hydrogen group and a functional group that can react to the active hydrogen group of the compound. For example, in the case where a polyester (polyester prepolymer (A)) including an isocyanate group is used as a polyester having a functional group that can react to an active hydrogen group, the polyester can be manufactured by the following method.

Polyol (1) and polycarboxylic acid (2) are heated at a temperature of 150 to 280° C. under the existence of a publicly known esterification catalyst such as tetrabutoxy titanate and dibutyltin oxide for generation while reducing pressure as necessary. Water is distilled to obtain a polyester including a hydroxyl group. Subsequently, polyisocyanate (3) is reacted to the polyester including a hydroxyl group at a temperature of 40 to 140° C. to obtain polyester prepolymer (A) including an isocyanate group (in the following, sometimes referred to as “prepolymer (A)”). Furthermore, amines (B), which are compounds including an active hydrogen group, are reacted to prepolymer (A) at a temperature of 0 to 140° C. to obtain a polyester modified with a urea bond.

For polyol (1), the following is named such as: alkaline glycol (such as ethylene glycol, 1,2-propylene glycol, 1,3-propylene glycol, 1,4-butanediol, 1,6-hexanediol); alkylene ether glycol (such as diethylene glycol, triethylenetetramine glycol, dipropylene glycol, polyethylene glycol, polypropylene glycol, and poly tetramethylene ether glycol); cycloaliphatic diol (such as 1,4-cyclohexanedimethanol and hydrogenated bisphenol A); bisphenols (such as bisphenol A, bisphenol F, and bisphenol S); an alkaline oxide adduct of the cycloaliphatic idols (such as ethylene oxide, propylene oxide, and butylene oxide); and an alkaline oxide adduct of the bisphenols (such as ethylene oxide, propylene oxide, and butylene oxide), and two kinds or more of them may be combined. Particularly, the following can be exemplified such as alkaline glycols having a carbon number of 2 to 12 and an alkylene oxide adduct of bisphenols (for example, a bisphenol A ethylene oxide (two moles) adduct, a bisphenol Apropylene oxide (two moles) adduct, and a bisphenol A propylene oxide (three moles) adduct, and so on).

For trivalent polyols or more, the following can be exemplified such as: polyaliphatic alcohol (such as glycerin, trimethylolethane, trimethylolpropane, and pentaerythritol, sorbitol); trivalent phenols or more (such as phenol novolac and cresol novolac); and alkaline oxide adducts of trivalent polyphenols or more, and two kinds or more of them may be combined. For polycarboxylic acid (2), the following is named such as: alkylene dicarboxylic acids (such as succinic acid, adipic acid, and sebacic acid); alkenyle nedicarboxylic acids (such as maleic acid and fumaric acid); and aromatic dicarboxylic acids (such as terephthalic acid, isophthalic acid, and naphthalene dicarboxylic acid), and two kinds or more of them may be combined. Particularly, alkenyle nedicarboxylic acids having a carbon number of 4 to 20 and aromatic dicarboxylic acids having a carbon number of 8 to 20 are preferable.

Moreover, for trivalent polycarboxylic acid (2) or more, aromatic polycarboxylic acids having a carbon number of 9 to 20 (such as trimellitic acid and pyromellitic acid) can be exemplified, for example. Two kinds or more of them may be combined. It is noted that anhydrides of polycarboxylic acid or lower alkyl esters (such as methyl ester, ethyl ester, and isopropyl ester) may be used instead of polycarboxylic acids.

For polyisocyanate (3), isocyanate agents are named. Furthermore, for amines (B), the foregoing amines are named. In reacting polyisocyanate (3) or in reacting prepolymer (A) to amines (B), a solvent may be used as necessary. For solvents that can be used, solvents inert to isocyanate (3) are named such as: aromatic solvents (such as toluene and xylene); ketones (such as acetone, methylethyl ketone, and methylisobutyl ketone); esters (such as acetic acid ethyl); and amides (such as dimethylformamide and dimethyl acetoamide) and ethers (such as tetrahydrofuran).

In the case where an unmodified polyester (unmodified polyester (ii)) is used together, unmodified polyester (ii) is manufactured by a method similar to the method for the polyester including a hydroxyl group, and unmodified polyester (ii) is dissolved and mixed in a liquid solution after the completion of reaction of modified polyester (i).

For the foregoing aqueous medium (in an aqueous phase), water may be simply used, or a solvent mixed in water may be used together. For the solvent mixed in water, the following is named such as alcohols (such as methanol, isopropanol, and ethylene glycol), dimethylformamide, tetrahydrofuran, cellosolves (such as methylcellosolve), and lower ketones (such as acetone and methylethyl ketone). Moreover, for the aqueous medium (in an aqueous phase), surfactants described later or dispersants such as a polymer protective colloid or the like may be included.

In forming the toner base particle, in the case of using a polyester (polyester prepolymer (A)) including an isocyanate group and amines (B) for a binder resin precursor, such methods may be used in which polyester prepolymer (A) and amines (B) are reacted in an aqueous medium to form a modified polyester (a urea modified polyester (modified polyester (i)), or in which polyester prepolymer (A) and amines (B) are reacted in advance to manufacture a modified polyester (a urea modified polyester (modified polyester (i))) for use.

For a method of stably forming a urea modified polyester (modified polyester (i)) or a dispersion of polyester prepolymer (A) and amines (B) in an aqueous medium, such a method may be named in which a composition of a toner material (a raw material) including modified polyester (i), or prepolymer (A) and amines (B), another binder resin (such as crystalline polyester), and a release accelerator is added in an aqueous medium and they are dispersed by shearing force, for example.

Polyester prepolymer (A) may be mixed with the other toner compositions (in the following, referred to as “toner raw materials”) including a coloring agent (or a coloring agent masterbatch), a release accelerator, a crystalline polyester, an unmodified polyester, and a charge control agent in forming a dispersion in an aqueous medium. More preferably, the toner raw materials are mixed with each other in advance, and the mixture is added and dispersed in an aqueous medium.

It is unnecessary to mix the toner raw materials such as a coloring agent and a charge control agent in forming a particle in an aqueous medium. The toner raw materials may be added after forming a particle. For example, such a configuration may be possible in which a particle including no coloring agent is formed and then a coloring agent is added by a publicly known coloring method.

The dispersion method is not limited particularly. Publicly known facilities can be applied such as a low speed shearing type, high speed shearing type, friction type, high pressure jet type, ultrasonic wave facility. In order to form the particle diameter of the dispersion to be 2 to 20 μm, a high speed shearing type is preferable. In the case where a high speed shearing type dispersion device is used, the number of revolutions is not restricted particularly. The number of revolutions is generally 1,000 to 30,000 rpm, preferably, 5,000 to 20,000 rpm. The dispersion period is not restricted particularly. In the case of a batch type, the number of revolutions is generally 0.1 to 5 minutes. The temperature in dispersion is generally a temperature of a temperature of 0 to 150° C. (under a pressure), preferably, a temperature of 40 to 98° C. High temperatures are preferable in that the viscosity of a dispersion of a urea modified polyester (modified polyester (i)) or polyester prepolymer (A) is low and dispersion is easily performed.

The amount of an aqueous medium used with respect to 100 parts by weight of the toner material (the toner composition) including modified polyester (i) or polyester prepolymer (A) and amines (B) is generally 50 to 2,000 parts by weight, preferably, 100 to 1,000 parts by weight. When the amount of an aqueous medium used is less than 50 parts by weight, the dispersed state of the toner composition is poor, and a toner particle in a predetermined particle diameter is not obtained. On the other hand, when the amount of an aqueous medium used exceeds 20,000 parts by weight, costs are expensive.

Moreover, a dispersant may be used as necessary as described above. Preferably, a dispersant is used because the grain size distribution becomes sharp, and dispersion is stable.

The process step of synthesizing a urea modified polyester (modified polyester (i)) from polyester prepolymer (A) and amines (B) may be configured in which amines (B) are added and reacted before dispersing a toner material solution (in an oil phase) in advance including polyester prepolymer (A) in an aqueous medium, or a toner material solution (in an oil phase) including polyester prepolymer (A) is dispersed in an aqueous medium and then amines (B) are added and reacted (reaction on the particle interface). In this case, such a configuration may be possible in which a urea modified polyester is in priority generated on the surface of a toner base particle to be formed and a density gradient is provided in the inside of the particle.

A surfactant can be used for a dispersant that emulsifies and disperses an undiluted toner material solution (in an oil phase) dispersed with the toner material (the toner composition) in a liquid (an aqueous medium (in an aqueous phase)) including water. For the surfactant, the following is named such as: anion surfactants including alkylbenzene sulfonate, α-olefin sulfonate, and phosphate; quaternary ammonium salt cation surfactants including amine salts such as alkylamine salts, amino alcohol fatty acid derivatives, polyamine fatty acid derivatives, imidazoline, and alkyltrimethyl ammonium salts, dialkyldimethylammonium salts, alkyldimethyl benzyl ammonium salts, pyridinium salts, and alkyl isoquinolinium salts, and benzethonium chlorides; and nonionic surfactants such as fatty acid amidederivatives and polyalcohol derivatives including amphoteric surfactants including alanine, dodecyldi(aminoethyl)glycine, di(octylaminoethyl)glycine, and N-alkyl-N,N-dimethylammonium betaine.

Moreover, a surfactant having a fluoroalkyl group is used to exert the effect with a very small amount. For anionic surfactants having a fluoroalkyl group preferably for use, the following is named such as fluoroalkylcarboxylic acids having a carbon number of 2 to 10 and the metallic salts, perfluorooctanesulfonylglutamic acid disodium, 3-[omega-fluoroalkyl(C6 to C11)oxy)-1-alkyl(C3 to C4) sulfonic acid sodium, 3-[omega-fluoroalkanoyl(C6 to C8)-N-ethyl amino]-1-propane sulfonic acid sodium, fluoroalkyl(C11 to C20) carboxylic acid and the metallic salts, perfluoroalkylcarboxylic acid (C7 to C13) and the metallic salts, perfluoroalkyl(C4 to C12) sulfonic acid and the metallic salts, perfluorooctanesulfonic acid diethanol amide, N-propyl-N-(2-hydroxyethyl)perfluorooctane sulfonamide, perfluoroalkyl(C6 to C10)sulfonamide propyltrimethyl ammonium salts, perfluoroalkyl(C6 to C10)-N-ethylsulfonylglycine salts, and mono perfluoroalkyl(C6 to C16)ethyl phosphate. For trade names, the following is named such as SURFLON S-111, S-112, and S-113 (made by ASAHI GLASS CO., LTD), Fluorad FC-93, FC-95, FC-98, and FC-129 (made by Sumitomo 3M Ltd.), UNIDYNE DS-101, DS-102, (made by Daikin Industries, Ltd.), Megafac F-110, F-120, F-113, F-191, F-812, and F-833 (made by DIC Corporation), Eftop EF-102, 103, 104, 105, 112, 123A, 123B, 306A, 501, 201, and 204, (made by Tochem Products Co., Ltd.), and FTERGENT F-100 and F150 (made by Neos Company Limited).

Furthermore, the cationic surfactants include a primary or secondary aliphatic series having a fluoroalkyl group, or amide acid, aliphatic quaternary ammonium salts such as perfluoroalkyl(C6 to C10)sulfonamide propyltrimethylammonium salts, and benzalkonium salts, benzethonium chloride, pyridinium salts, and imidazolium salts. For trade names, the following is named such as SURFLON S-121 (made by ASAHI GLASS CO., Ltd), Fluorad FC-135 (made by Sumitomo 3M Ltd.), Unidyne DS-H0202 (made by Daikin Industries, ltd.), Megafac F-150, F-824 (made by DIC Corporation), Ekutop EF-132 (made by Tochem Products Co., Ltd.), and Ftergent F-300 (made by Neos Company Limited).

In addition, for poorly water-soluble inorganic compound dispersants, the following can be used such as tricalcium phosphate, calcium carbonate, titanium oxide, colloidal silica, and hydroxyapatite. Moreover, a polymer protective colloid is used to stabilize dispersion droplets. For the polymer protective colloid, for example, the following can be used such as: acids including acrylic acid, methacrylic acid, α-cyanoacrylic acid, α-cyanomethacrylic acid, itaconic acid, crotonic acid, fumaric acid, maleic acid, and anhydrous maleic acid; (meta) acrylic monomers including a hydroxyl group, for example, β-hydroxy ethy lacrylate, β-hydroxy ethyl methacrylate, β-hydroxypropyl acrylate, β-hydroxypropyl methacrylate, acrylic acid γ-hydroxypropyl, γ-hydroxypropyl methacrylate, acrylic acid 3-chloro-2-hydroxypropyl, methacrylic acid 3-chloro-2-hydroxypropyl, diethylene glycol mono acrylic ester, diethylene glycol mono methacrylate ester, glycerin mono acrylic ester, glycerin mono methacrylate ester, N-acrylic amide, and N-methylol methacrylamide; vinyl alcohols or vinyl alcohol ethers, for example, vinyl methyl ether, vinyl ethyl ether, and vinyl propylether; ester compounds including a vinyl alcohol and a carboxyl group, for example, vinyl acetate, propionic acid vinyl, and butyric acid vinyl; acrylic amide, amide, diacetone acrylic amide, or methylol compounds of them; acid chlorides such as acrylic acid chloride and methacryloyl chloride; homopolymers or copolymers including nitrogen atoms of vinylpyridine, vinyl pyrrolidone, vinyl imidazole, and ethylene immune, for example, and including a heterocycle of them; polyoxyethylene, polyoxypropylene, polyoxyethylene alkylamine, polyoxypropylene alkylamine, polyoxyethylene alkylamide, polyoxypropylene alkylamide, polyoxyethylene nonylphenyl ether, polyoxyethylene laurylphenyl ether, polyoxyethylene stearylphenyl ether, and polyoxyethylene nonylphenyl ether; and celluloses such as methyl cellulose, hydroxy ethyl cellulose, and hydroxypropyl cellulose.

It is noted that in the case where an acid or an alkaline dissolvable stabilizer such as phosphoric acid calcium salt is used for a stabilizer, phosphoric acid calcium salt is dissolved using an acid such as hydrochloric acid, and then phosphoric acid calcium salt is removed from fine particles by a method as by rinsing with water. In addition, phosphoric acid calcium salt can be removed by operation such as decomposition suing an enzyme. In the case where a dispersant is used, the dispersant may be left on the toner particle surface. Preferably, the dispersant is cleaned and removed after an elongation reaction, a cross-linking reaction, or elongation and cross-linking reactions, from the viewpoint of the charging surface of the toner.

Moreover, in order to reduce the viscosity of an undiluted toner material solution (in an oil phase) dissolved or dispersed with the toner material (the toner composition), a solvent in which modified polyester (i) or prepolymer (A) is soluble may be used. The use of such a solvent is preferable because the grain size distribution becomes sharp. Preferably, the boiling point of a solvent for use is of volatility at a temperature of less than 100° C. because the solvent is easily removed. For the solvent, the following can be used alone or the combination of two kinds or more, for example, toluene, xylene, benzene, carbon tetrachloride, methylene chloride, 1,2-dichloro-ethane, 1,1,2-trichloroethane, trichloroethylene, chloroform, monochlorobenzene, dichloro-ethylidene, acetic acid methyl, acetic acid ethyl, methylethyl ketone, and methylisobutyl ketone. Particularly, the following is preferable such as aromatic solvents including toluene and xylene, and halogenated hydrocarbons including methylene chloride, 1,2-dichloro-ethane, chloroform, and carbon tetrachloride. The amount of a solvent used with respect to 100 parts by weight of polyester prepolymer (A) is generally 0 to 300 parts by weight, preferably, 0 to 100 parts by weight, and more preferably, 25 to 70 parts by weight. In the case of using a solvent, the solvent is heated at a normal pressure or a reduced pressure and removed, after an elongation reaction, a cross-linking reaction, or elongation and cross-linking reactions.

The cross-link reaction period for elongation, cross-linking, or elastic cross-linking is selected according to reactivity by the combination of the isocyanate group structure of polyester prepolymer (A) and amines (B). Generally, the period is 10 minutes to 40 hours, preferably, 2 to 24 hours. Generally, the reaction temperature is a temperature of 0 to 150° C., preferably, a temperature of 40 to 98° C. Moreover, a publicly known catalyst can be used as necessary. More specifically, dibutyltin laurate and dioctyltin laurate are named, for example.

In order to remove an organic solvent from an emulsified dispersion obtained by emulsifying or dispersing an undiluted toner material solution (in an oil phase) in an aqueous medium (in an aqueous phase), such a method can be adopted in which the temperature of the entire system is gradually increased and the organic solvent in droplets is fully evaporated and removed. Alternatively, such a method may be possible in which the emulsified dispersion is sprayed in a dry atmosphere, a water-insoluble organic solvent in droplets is fully removed to form fine particles to be the toner base particle, and a water type dispersant is also evaporated and removed. For the dry atmosphere in which the emulsified dispersion is sprayed, generally, the dry atmosphere includes gases that air, nitrogen, carbon dioxide gas, combustion gas, or the like is heated, more particularly, various air currents which are heated at a temperature or more of the boiling point of the maximum boiling point of a solvent for use. A targeted quality can be sufficiently obtained using a spray dryer, belt dryer, and rotary kiln, for example.

In the case where the grain size distribution becomes wide in emulsification and dispersion, the grain size distribution can be adjusted by classifying fine particles into a desired grain size distribution, even though cleaning and drying are performed while maintaining the grain size distribution. For a classification method, a method can be exemplified in which fine particles in unnecessary sizes are removed using a cyclone or a decanter, and by centrifugal separation, for example. Such a method may be possible in which particles are dried for powder and then classified. Preferably, particles are classified in a liquid because of efficiency. Fine particles or coarse particles in unnecessary sizes removed by classification can be used for forming particles by returning the particles to the kneading process step. In the returning, fine particles or coarse particles may be wet. For the dispersant, it is preferable to remove the dispersant from the dispersion as much as possible. Preferably, the dispersant is removed from the dispersion simultaneously with the foregoing classification operation.

Dried powder (the toner base particle) is mixed with different kinds of particles such as a release accelerator fine particle, a charge controlling fine particle, a superplasticizer fine particle, and a coloring agent fine particle as necessary, or mechanical impact force is applied to mixed powder, so that toner including the toner base particle is obtained. Mechanical impact force is applied, so that it can be prevented that different kinds of particles are desorbed from the surface of the toner including the toner base particle (a complex particle) to be obtained.

Specific means to apply mechanical impact force include such methods in which impact force is applied to a mixture using blades rotating at high speed, and in which a mixture is put into a high-speed air current and accelerated and particles or complex particles are collided against an appropriate impact plate. The devices include ANGMILL (made by Hosokawa Micron Corp.), a device in which I type mill (made by NIPPON PNEUMATIC MFG. CO., LTD.) is altered to reduce a milling air pressure, HYBRIDIZATION SYSTEM (made by Nara Machinery Co., Ltd.), CRYPTRON SYSTEM (made by Kawasaki Heavy Industries, Ltd.) and an automatic mortar, and the like.

Preferably, the content ratio between the carrier and the toner is 1 to 10 parts by weight of the toner with respect to 100 parts by weight of the carrier. For magnetic carriers, publicly known, previously existing powders can be used such as iron powder, ferrite powder, magnetite powder, and magnetic resin carriers having a particle diameter of about 20 to 200 μm, for example.

For the coating material of the magnetic carrier, amino resins are named, for example, urea-formaldehyde resins, melamine resins, benzoguanamine resins, urea resins, polyamide resins, and epoxy resins. Moreover, the following can be used such as: polyvinyls and polyvinylidene resins, for example, acrylic resins, polymethylmethacrylate resins, polyacrylonitrile resins, polyvinyl acetate resins, polyvinyl alcohol resins, and polyvinyl butyral resins; polystyrene resins such as polystyrene resins and styreneacrylic copolymer resins; halogenated olefin resins such as polyvinyl chlorides; polyester resins such as polyethylene terephthalate resins and polybutylene terephthalate resins; polycarbonate resins such as polyethylene resins, polyvinyl fluoride resins, polyvinylidene fluoride resins, poly trifluoroethylene resins, polyhexafluoropropylene resins; copolymers of vinylidene fluorides and acrylic monomers; copolymers of vinylidene fluorides and vinyl fluorides; fluoroterpolymers such as terpolymers of tetrafluoroethylenes, vinylidene fluorides, and non-fluoride monomers; and silicone resins. Moreover, conductive powder or the like may be included in a coating resin as necessary. For the conductive powder, metal powders, carbon black, titanium oxides, tin oxidizes, zinc oxidizes, or the like can be used. Preferably, these conductive powders have an average particle diameter of 1 μm or less. When an average particle diameter exceeds 1 μm, it is difficult to control electrical resistance. Furthermore, the toner according to the present invention can also be used as a one-component developer that no carrier is used (a magnetic toner or a nonmagnetic toner).

Next, the experiments conducted by the present inventors will be described.

In order to obtain toners of various properties, the present inventors first prepared toner materials as described below.

<Synthesization of Organic Fine Particle Emulsion>

In a reaction chamber to which a stirring rod and a thermometer are set, 700 parts by weight of water, 12 parts by weight of sodium salt of ethylene oxide methacrylate adduct sulfuric acid ester (ELEMINOL RS-30 (made by Sanyo Chemical Industry Co, Ltd.)), 140 parts by weight of styrene, 140 parts by weight of methacrylic acid, and 1.5 parts by weight of ammonium persulfate were included. Then, the mixture was stirred at a 45° rotation/minute for 20 minutes to obtain a white emulsion, the temperature of the emulsion was increased to a system temperature of 75° C., and the emulsion was reacted for five hours. 35 parts by weight of ammonium persulfate aqueous solution (1%) was added to the emulsion, the mixture was maturated for five hours at a temperature of 75° C., and an aqueous dispersion “fine particle dispersion 1” of a vinyl resin (a sodium salt copolymer of styrene-methacrylic acid-ethylene oxide methacrylate adduct sulfuric acid ester) was obtained. When the volume average particle diameter of the “fine particle dispersion 1” was measured using LA-920, (the detail will be described later), the volume average particle diameter was 0.30 μm. A part of “fine particle dispersion 1” was dried to isolate a resin portion. Tg of the resin portion was a temperature of 155° C.

<Preparation of an Aqueous Phase>

1,000 parts by weight of water, 85 parts by weight of “fine particle dispersion 1”, 40 parts by weight of an aqueous solution (50%) of dodecyldiphenyl ether disulfonic acid sodium (ELEMINOL MON-7 (made by Sanyo Chemical Industry Co, Ltd.)), and 95 parts by weight of acetic acid ethyl were mixed and stirred, and a translucent white liquid was obtained. The mixture was aqueous phase 1.

<Synthesization of a Low Molecule Polyester (a Polyester Including a Hydroxyl Group)>

In a reaction chamber equipped with a cooling pipe, a stirrer, and nitrogen introduction pipe, 235 parts by weight of a bisphenol A ethylene oxide (two moles) adduct, 535 parts by weight of a bisphenol A propylene oxide (three moles) adduct, 215 parts by weight of terephthalic acid, 50 parts by weight of adipic acid, and 3 parts by weight of dibutyltin oxide were included. The mixture was reacted at a temperature of 240° C. for ten hours under a normal pressure, and then reacted at a reduced pressure of 10 to 20 mmHg for six hours. After that, 45 parts of trimellitic anhydrid was put into a reaction chamber, the mixture was reacted at a temperature of 185° C. at a normal pressure for three hours, and “low-molecular polyester 1” was obtained. The “low-molecular polyester 1” had a number average molecular weight of 2,800, a weight average molecular weight of 7,100, Tg of 45° C., and an acid value of 22 mgKOH/g.

<Synthesization of Polyester Prepolymer (Polyester Prepolymer Including an Isocyanate Group)>

In a reaction chamber equipped with a cooling pipe, a stirrer, and nitrogen introduction pipe, 700 parts by weight of a bisphenol A ethylene oxide (two moles) adduct, 85 parts by weight of a bisphenol Apropylene oxide (two moles) adduct, 300 parts by weight of terephthalic acid, 25 parts of trimellitic anhydrid, and 3 parts by weight of dibutyltin oxide were included. The mixture was reacted at a normal pressure at a temperature of 240° C. for ten hours, and reacted under an environment at a reduced pressure of 10 to 20 mmHg for six hours, and “intermediate polyester 1” was obtained. The “intermediate polyester 1” had a number average molecular weight of 2,500, a weight average molecular weight of 10,000, Tg of 58° C., an acid value of 0.5 mgKOH/g, and a hydroxyl value of 52 mgKOH/g.

Subsequently, in a reaction chamber equipped with a cooling pipe, a stirrer, and nitrogen introduction pipe, 400 parts by weight of “intermediate polyester 1”, 90 parts by weight of isophoronediisocyanate, and 500 parts of acetic acid ethyl were included. The mixture was then reacted at a temperature of 110° C. for six hours, and “prepolymer 1” was obtained. The percent by weight of free isocyanate of “prepolymer 1” was 1.67%.

<Synthesization of Crystalline Polyester 1>

In a five-liter four-necked flask equipped with a nitrogen introduction pipe, a dewatering pipe, a stirrer, and a thermocouple, 28 moles of 1,4-butanediol, 24 moles of fumaric acid, 1.80 moles of trimellitic anhydrid, and 6.0 g of hydroquinone were included. The mixture was reacted at a temperature of 160° C. for six hours, and a temperature was increased at a temperature of 200° C. to react the mixture. The mixture was reacted at a pressure of 8.3 KPa for one hour, and “crystalline polyester 1” was obtained. The “crystalline polyester 1” had a melting point (a heat absorption peak temperature by DSC) 150° C., Mn of 800, and Mw of 3,000.

<Synthesization of Crystalline Polyester 2>

In a five-liter four-necked flask equipped with a nitrogen introduction pipe, a dewatering pipe, a stirrer, and a thermocouple, 28 moles of 1,4-butanediol, 24 moles of fumaric acid, 1.80 moles of trimellitic anhydrid, 6.0 g of hydroquinone were included. The mixture was reacted at a temperature of 120° C. for three hours, and the temperature was increased at a temperature of 180° C. for 0.5 hour. The mixture was reacted at a pressure of 8.3 KPa for 0.5 hour, and “crystalline polyester 2” was obtained. The “crystalline polyester 2” had a melting point (a heat absorption peak temperature by DSC) of 50° C., Mn of 500, and Mw of 1,000.

<Synthesization of Ketimine>

In a reaction chamber to which a stirring rod and a thermometer are set, 180 parts by weight of isophorone diamine and 80 parts by weight of methylethyl ketone were included, the mixture was reacted at a temperature of 50° C. for six hours, and “ketimine compound 1” was obtained. The amine value of the “ketimine compound 1” was 420 mgKOH/g.

<Synthesization of a Masterbatch (MB)>

1,300 parts by weight of water, 550 parts by weight of carbon black (Printex 35 made by DEGUSSA) (DBP oil absorption=43 ml/100 mg, pH=9.5), and 1,300 parts by weight of polyester were added, and the mixture was mixed using Henschel mixer (made by Mitsui Mining Co., Ltd.,). The mixture was kneaded using a two-roll mill at a temperature of 160° C. for 45 minutes, rolled and cooled, and pulverized using a pulverizer, and masterbatch 1 was obtained.

<Preparation of an Oil Phase (Pigment-Wax Dispersion 1)>

In a container in which a stirring rod and a thermometer were set, 400 parts by weight of “low-molecular polyester 1”, 100 parts by weight of a microcrystalline wax (an acid value of 0.1 mgKOH/g, a melting point of 65° C., a carbon number of 20, and 70 percent by weight of straight-chain hydrocarbon), 20 parts by weight of CCA (salicylic acid metal complex E-84 made by Orient Chemical Industries Co., Ltd.), and acetic acid ethyl 1,000 parts by weight were included. The temperature was increased at a temperature of 80° C. while stirring the mixture, and the mixture was allowed stand for eight hours at a temperature of 80° C., and cooled at a temperature of 24° C. for one hour. Subsequently, 480 parts by weight of “masterbatch 1” and 550 parts of acetic acid ethyl were included in the container, the mixture was mixed for one hour, and “raw material dissolved solution 1” was obtained. The “raw material dissolved solution 1” was included in a different container, and 80 percent by volume of zirconia beads in a diameter of 0.5 mm was filled at a flowing velocity of 1 kg/hr and a disk circumferential velocity of 6 m/second using a bead mill (Ultra Visco Mill, made by Aimex CO., Ltd.). Carbon black and a wax were then dispersed under the three-pass conditions. After that, 1,000 parts by weight of 65% acetic acid ethyl solution of “low-molecular polyester 1” were added, the mixture was passed using the bead mill under the foregoing conditions, and “pigment-wax dispersion 1” was obtained. The solid content density of the “pigment-wax dispersion 1” was 53 percent by weight (at a temperature of 130° C. for 30 minutes).

<Preparation of an Oil Phase (Pigment-Wax Dispersion 2)>

“Pigment-wax dispersion 2” was obtained as similarly prepared as “pigment-wax dispersion 1” except that the microcrystalline wax used in the preparation of” pigment-wax dispersion 1″ was changed to have an acid value of 0.1 mgKOH/g, a melting point of a temperature of 90° C., a carbon number of 80, and 55 percent by weight of straight-chain hydrocarbon,

<Preparation of an Oil Phase (Pigment-Wax Dispersion 3)>

“Pigment-wax dispersion 3” was obtained as similarly prepared as “pigment-wax dispersion 1” except that the microcrystalline wax used in the preparation of “pigment-wax dispersion 1” was changed to a carbon number of 85 and 50 percent by weight of straight-chain hydrocarbon.

<Preparation of a Crystalline Polyester Dispersion>

110 g of “crystalline polyester 1” and 450 g of acetic acid ethyl were put into a two-liter metal container, and the mixture was heated and dissolved or heated and dispersed at a temperature of 80° C., and quickly cooled in an ice-water bath. 500 ml of glass beads (a diameter of 3 mm) was added in the mixture, and stirred for ten hours using a batch sand mill device (made by Kanpe Hapio Co., Ltd.), and “crystalline polyester dispersion 1” having a volume average particle diameter of 0.4 μm was obtained.

Moreover, “crystalline polyester dispersion 2” was obtained similarly as described above except that 110 g of “crystalline polyester 1” was changed to 110 g of “crystalline polyester 2”.

Next, the present inventors manufactured the toner using these materials.

### Example 1

First, the following emulsification process step was performed. Namely, 700 parts by weight of “pigment-wax dispersion 3,” 120 parts by weight of “prepolymer 1,” 80 parts by weight of “crystalline polyester dispersion 1,” and 5 parts by weight of “ketimine compound I” were put into a container. The mixture was mixed at 6,000 rpm for one minute using TK homo mixer (made by Primix Corporation), 1,300 parts by weight of “aqueous phase 1” was added into the container, the mixture was mixed at a number of revolutions 13,000 rpm for 20 minutes using TK homo mixer, and “emulsification slurry 1” was obtained.

Subsequently, the following desolvation process step was performed. Namely, “emulsification slurry 1” was put into a container in which a stirrer and a thermometer were set, desolvated at a temperature of 30° C. for ten hours, the mixture was maturated at a temperature of 45° C. for five hours, and “dispersion slurry 1” was obtained.

After that, 100 parts by weight of “emulsification slurry 1” was filtered at a reduced pressure.

(1) 100 parts by weight of ion ion-exchanged water were added in a filter cake, mixed at a number of revolutions of 12,000 rpm using TK homo mixer, and then filtered.

(2) 100 parts by weight of 10% sodium hydrate aqueous solution were added to the filter cake in (1), mixed at a number of revolutions of 12,000 rpm using TK homo mixer, and filtered at a reduced pressure.

(3) 100 parts by weight of 10% hydrochloric acid were added to the filter cake in (2), mixed at a number of revolutions of 12,000 rpm for 10 minutes using TK homo mixer, and then filtered.

(4) 300 parts by weight of ion ion-exchanged water were added to the filter cake in (3), mixed at a number of revolutions of 12,000 rpm for 10 minutes using TK homo mixer, filtered twice, and “filter cake 1” was obtained. This “filter cake 1” was dried at a temperature of 45° C. for 48 hours using a circulation dryer, and sieved through a mesh having an aperture of 75 μm, and “toner base particle 1” was obtained.

0.4 parts by weight of hydrophobic silica and 0.4 parts by weight of hydrophobic titanium oxide were mixed with respect to 100 parts by weight of “toner base particle 1” thus obtained using Henschel mixer, and a toner particle including a toner base particle was formed. The toner volume average particle diameter was 6 and the toner particle diameter ratio was 1.25. For the conditions in evaluating gloss unevenness, such a fixing unit was used in which a system linear velocity was 1,700 mm/sec, the layer thickness L1 of silicone rubber was 750 μm, and the layer thickness L2 of fluorine resin was 2 μm.

### Example 2

For the conditions in evaluating gloss unevenness, experiments were similarly conducted as in Example 1 except that was changed to a system linear velocity of 1,700 mm/sec to 400 mm/sec.

### Example 3

For the conditions in evaluating gloss unevenness, experiments were similarly conducted as in Example 2 except that such a fixing unit is used in which the layer thickness L1 of silicone rubber was changed to 400 μm, and the layer thickness L2 of fluorine resin was changed to 2 μm.

### Example 4

Experiments were similarly conducted as in Example 3 except that 80 parts by weight of “crystalline polyester dispersion 1” used in Example 3 was changed to 5 parts by weight.

### Comparative Example 1

Experiments were similarly conducted as in Example 1 except that 80 parts by weight of crystalline “polyester dispersion 1” used in Example 1 was changed to 4 parts by weight.

### Example 5

Experiments were similarly conducted as in Example 4 except that “pigment-wax dispersion 3” used in Example 4 was changed to “pigment-wax dispersion 2”.

### Example 6

Experiments were similarly conducted as in Example 4 except that “pigment-wax dispersion 3” used in Example 4 was changed to “pigment-wax dispersion 1”.

### Example 7

Experiments were similarly conducted as in Example 6 except that 700 parts by weight of “pigment-wax dispersion 1” used in Example 6 was changed to 35 parts by weight.

### Example 8

Experiments were similarly conducted as in Example 6 except that “crystalline polyester dispersion 1” used in Example 6 was changed to “crystalline polyester dispersion 2”.

### Example 9

Experiments were similarly conducted as in Example 6 except that a toner volume average particle diameter of 6 μm used in Example 6 was changed to 3 μm, and a toner particle diameter ratio of 1.25 was changed to 1.05.

### Example 10

Experiments were similarly conducted as in Example 1 except that 0.4 parts by weight of hydrophobic silica and 0.4 parts by weight of hydrophobic titanium oxide used in Example 1 were changed to 3.0 parts by weight of hydrophobic silica and 2.0 parts by weight of hydrophobic titanium oxide.

### Comparative Example 2

Experiments were similarly conducted as in Example 1 except that 0.4 parts by weight of hydrophobic silica and 0.4 parts by weight of hydrophobic titanium oxide used in Example 1 were changed to 3.5 parts by weight of hydrophobic silica and 2.5 parts by weight of hydrophobic titanium oxide.

The present inventors measured these toners on the carbon number, the straight-chain hydrocarbon content wt % of the release accelerator (the microcrystalline wax), the melting point of the release accelerator, and the heat absorption peak temperature of amorphous polyester resin included as a binder resin.

The carbon number and average carbon number of the release accelerator were measured according to high-temperature gel permeation chromatography (high temperature GPC). The carbon number is a value that a molecular weight when starting the flow of a chromatogram measured by high temperature GPC is divided by a molecular weight of 14 of a methylene group and a value that a molecular weight when ending the flow of the chromatogram is divided by a molecular weight of 14 of a methylene group, and expresses the dispersion of carbons forming a hydrocarbon. Moreover, the average carbon number is a value that a peak molecular weight of a chromatogram measured by high temperature GPC is divided by a molecular weight of 14 of a methylene group.

The molecular weight was measured as follows. Namely, o-dichlorobenzene added with 0.1% of ionol was used as a solvent, and flowed under the temperature conditions at a temperature of 135° C., molecules were detected using a differential refractometer detector, and a molecular weight was found by the absolute molecular weight conversion of polyethylene according to universal calibration.

The straight-chain hydrocarbon content of the release accelerator was measured by gas chromatography. In moving a mixture of a straight-chain hydrocarbon and a non-straight-chain hydrocarbon in a stationary phase with a carrier gas, the rates of travel are different due to a difference in adsorption from the stationary phase or in dispersion. Therefore, the straight-chain hydrocarbon and the non-straight-chain hydrocarbon are separated. The content of the straight-chain hydrocarbon is calculated from the ratio between peak holding time and a peak area appearing in a gas chromatogram. For a separation column, a packed column or a capillary column is used. For the packed column, such columns are used in which an adsorptive material such as activated carbon, activated alumina, silica gel, porous spherical silica, a molecular sieve, and mineral salts is used for a filler, or paraffin oil, silicone oils, or the like coated in a thin film on the surface of a fine particle such as diatomite, firebrick powder, glass silica bead, fused silica bead, and graphite. The capillary column uses no filler, and the paraffin oils, silicone oils, or the like are coated for use. For the carrier gas, nitrogen, helium, hydrogen, or argon is used. Moreover, for the detector, a heat radiation thermal conductivity detector, an aerometer, an ionization cross section detector, or an ionization detector (hydrogen flames, β-rays, electron capture waves, or radio frequency waves) is used. It is noted that hydrocarbon of the release accelerator was obtained, in which hydrocarbon was separated and purified from a vacuum distillation residual oil or a heavy distillate oil of petroleum, and further split by high temperature GPC.

The melting point of the release accelerator is the temperature of a heat absorption peak at which the quantity of heat absorbed is the maximum in differential thermal curves obtained by differential scanning calorimetry (DSC). The heat absorption peak temperature of a crystalline polyester resin was also measured by differential scanning calorimetry.

Next, the present inventors analyzed the infrared absorption spectra of a crystalline polyester resin and an amorphous polyester resin of the binder resin. Infrared spectroscopic analysis was conducted by a KBr method (a total transmission method) using Avatar 370, which is an FT-IR (Fourier transform infrared spectrometer) made by ThermoElectron Corporation. The infrared absorption spectrum is a graph that the wave number of an infrared ray applied was plotted on the horizontal axis of two-dimensional coordinates and the absorbance was plotted on the vertical axis. Thus, it can be known what structure a substance to be analyzed has.

In the measurement of the additive content, the calibration curve of the additive was produced using a sample having an amount of the additive included in advance with fluorescent X-rays, and an application was produced in which the values of the amount of the additive included were detected as they were. An amount of the additive included is a part number of the additives with respect to 100 parts of toner base particles.

FIG. 4 shows exemplary infrared absorption spectra of a crystalline polyester resin. The infrared absorption spectrum of the crystalline polyester resin is significantly characterized in that as illustrated in FIG. 4, a single falling peak point exists between a falling peak point at which the absorbance is the minimum (in the following, referred to as a first falling peak point Fp1) and a falling peak point at which the absorbance is the second smallest (in the following, referred to as a second falling peak point Fp2). The falling peak point is defined as a third falling peak point Fp3 in the specification. Suppose that a segment connecting the first falling peak point Fp1 to the second falling peak point Fp2 is a base line. A perpendicular is drown from the third falling peak point Fp3 toward the horizontal axis, and an absolute value of a difference between the absorbance at an intersection point with the base line and the absorbance of the third falling peak point Fp3 is a height W of the third falling peak point Fp3.

FIG. 5 shows exemplary infrared absorption spectra of an amorphous polyester resin. As illustrated in FIG. 5, the infrared absorption spectrum of an amorphous polyester resin is significantly characterized in that a maximum rising peak point Mp at which the absorbance is the maximum becomes considerably large as compared with the other rising peak points. Suppose that a segment connecting the first falling peak point Fp1 to the second falling peak point Fp2 is a base line. Suppose that a perpendicular is drown from the maximum rising peak point Mp toward the horizontal axis, and an absolute value of a difference between the absorbance at an intersection point with the base line and the absorbance of the maximum rising peak point Mp is a height R of the maximum rising peak point Mp. Moreover, W/R is a peak ratio. Thus, the peak ratio W/R was measured for toner A to toner G as described above.

Subsequently, the toners A, B, C, D, E, F, and G were individually mixed in the copper-zinc ferrite carrier so as to manufacture developers A, B, C, D, E, F, and G. For the mixing ratio, a copper-zinc ferrite carrier was 90 percent by weight with respect to 10 percent by weight of the toner. For the mixing conditions, such conditions were adopted in which the mixture was mixed and stirred at a number of revolutions 71 rpm for five minutes using Turbula shaker mixer (Shinmaru Enterprises Corporation). For the copper-zinc ferrite carrier, such a carrier was used in which silicone resin was covered and an average particle diameter was 40 μm.

The developers were individually used to conduct printing tests. For a printer for use in the printing tests, RICOH Proc 901 (made by Ricoh Company, Ltd.) was altered in the configuration of the present invention for evaluation.

(Measurement of the System Velocity)

The system velocity was found by Equation below, where 100 A4 paper sheets were continuously and vertically fed and outputted using an image forming apparatus (the paper length in the feeding direction was 297 mm), described later, the output period from the start to the end was A seconds, and the system velocity was B.

B(mm/sec)=100(sheets)×297(mm)/A(sec)

In the printing tests, a test image at a coverage rate of 6% was continuously outputted on 50 thousands A3 size paper sheets. After the output, a single dot line was outputted as a sample image on three A3 size paper sheets, and gloss unevenness on the image surfaces of the sheets was visually evaluated. For the evaluation, sensory evaluation was conducted in which a single dot line image for a preprinted rank sample was visually compared with the sample image. A significantly excellent case was expressed by a double circle, an excellent case was expressed by a circle, a relatively poor case was expressed by a triangle, and a poor case was expressed by a cross for evaluation.

The experimental results are shown in Table 1 below.

TABLE 1

| | | | | | | | Wax | Wax Dsc | Wax | DSC Heat | Toner | | |
|---|---|---|---|---|---|---|---|---|---|---|---|---|---|
| | | | | | | | Straight- | Heat | Content | Absorp- | Volume | | |
| | | | | | Organic | Wax | Chain | Absorp- | Of Toner | tion Peak | Average | | |
| | System | | | | Fine | Carbon | Hydro- | tion Peak | Base | Tempera- | Particle | Particle | Gloss |
| | Velocity | L1 | L2 | | Particle | Number | carbon | Tempera- | Particle | ture Of C- | Diameter | Diameter | Uneven- |
| | (mm/sec) | (μm) | (μm) | W/R | Number | (%) | Content | ture (° C.) | (wt/%) | Poly (° C.) | (μm) | Ratio | ness |
| Example 1 | 1700 | 750 | 20 | 0.85 | 0.80 | 85 | 50 | 95 | 20 | 150 | 6 | 1.25 | ◯ |
| Example 2 | 400 | 750 | 20 | 0.85 | 0.80 | 85 | 50 | 95 | 20 | 150 | 6 | 1.25 | ◯ |
| Example 3 | 400 | 400 | 2 | 0.85 | 0.80 | 85 | 50 | 95 | 20 | 150 | 6 | 1.25 | ◯ |
| Example 4 | 400 | 400 | 2 | 0.045 | 0.80 | 85 | 50 | 95 | 20 | 150 | 6 | 1.25 | ◯ |
| Compara- | 400 | 400 | 2 | 0.043 | 0.80 | 85 | 50 | 95 | 20 | 150 | 6 | 1.25 | X |
| tive | | | | | | | | | | | | | |
| Example 1 | | | | | | | | | | | | | |
| Example 5 | 400 | 400 | 2 | 0.045 | 0.80 | 80 | 55 | 90 | 20 | 150 | 6 | 1.25 | ⊙ |
| Example 6 | 400 | 400 | 2 | 0.045 | 0.80 | 70 | 70 | 95 | 1 | 150 | 6 | 1.25 | ⊙ |
| Example 7 | 400 | 400 | 2 | 0.045 | 0.80 | 70 | 70 | 65 | 20 | 150 | 6 | 1.25 | ◯ |
| Example 8 | 400 | 400 | 2 | 0.045 | 0.80 | 70 | 70 | 65 | 20 | 50 | 6 | 1.25 | ◯ |
| Example 9 | 400 | 400 | 2 | 0.045 | 0.80 | 70 | 70 | 65 | 20 | 150 | 3 | 1.05 | ⊙ |
| Example | 1700 | 750 | 20 | 0.85 | 5.00 | 85 | 50 | 95 | 20 | 150 | 6 | 1.25 | ◯ |
| 10 | | | | | | | | | | | | | |
| Compara- | 1700 | 750 | 20 | 0.85 | 6.00 | 85 | 50 | 95 | 20 | 150 | 6 | 1.25 | X |
| tive | | | | | | | | | | | | | |
| Example 2 | | | | | | | | | | | | | |

Next, another embodiment that carries out the present invention will be described.

Attention is focused on the following, in which the specific mutual effect between the feature of the fixing unit, the property of the crystalline polyester resin, the property of the wax, and the additive is important because the effect of the exudation of the wax is insufficient only by the feature of the fixing unit and even a lack of one of the feature and properties fails to exert the effect of the present invention, in which the release agent in the toner is exuded to the toner surface neither too much nor too little in fixing and gloss unevenness produced in fixing can be sufficiently avoided. In the image forming apparatus according to the embodiment, the dispersion characteristics of an ester wax selected as a release agent are improved in the inside of the toner and the wax is easily exuded to the toner surface and that the particle diameter, type, and amount of inorganic fine particles, which affect the exudation of the wax, are defined.

More specifically, the release agent is formed of a microcrystalline wax, a synthetic ester wax, or a microcrystalline wax and a synthetic ester wax. At least a crystalline polyester resin and an amorphous polyester resin are included as binder resins. A ratio W/R of a height W of third falling peak point of an infrared absorption spectrum of the crystalline polyester resin to a height R of the maximum rising peak of an infrared absorption spectrum of the amorphous polyester resin, which are measured by an infrared spectroscopy (a KBr pellet method) using Fourier transform infrared spectrometer, is 0.045 or more and 0.850 or less. The content of inorganic fine particles is in a range of 0.4 to 5.0 parts by weight with respect to 100 parts of a toner base particles.

The image forming apparatus according to the embodiment has the configuration illustrated in FIG. 1. The configuration of the toner will be described.

For the toner for use in the image forming apparatus according to the embodiment, a microcrystalline wax, an ester wax, or a microcrystalline wax and an ester wax are used as the release agent.

Preferably, the synthetic ester wax is a synthetic ester wax among ester waxes. Moreover, preferably, the synthetic ester wax is a mono ester wax obtained using a saturated long-chain linear fatty acid and a saturated long-chain linear alcohol. For examples of the synthetic ester wax, a mono ester wax synthesized from a saturated long-chain linear fatty acid and a saturated long-chain linear alcohol is named.

The saturated long-chain linear fatty acid is expressed by a general formula CnH₂ₙ₊₁COOH, and these acids (n=about 5 to 28) are preferably used. The saturated long-chain linear alcohol is expressed by a general formula CnH₂ₙ₊₁OH, and these acids (n=about 5 to 28) are preferably used.

Specific examples of the saturated long-chain linear fatty acid here include capric acid, undecylic acid, lauric acid, tridecyl acid, myristic acid, pentadecylic acid, palmitic acid, heptadecanoic acid, tetradecanoic acid, stearic acid, nonadecanoic acid, arachic acid, behenic acid, lignoceric acid, cerinic acid, heptacosanoic acid, montanoic acid and melissic acid, and the like.

Specific examples of the saturated long-chain linear alcohol include amyl alcohol, hexyl alcohol, heptyl alcohol, octyl alcohol, capryl alcohol, nonyl alcohol, decyl alcohol, undecyl alcohol, laurylalcohol, tridecyl alcohol, myristyl alcohol, pentadecyl alcohol, cetyl alcohol, heptadecyl alcohol, stearyl alcohol, nonadecyl alcohol, eicosyl alcohol, ceryl alcohol and heptadecane-1-ol, and the like.

It is noted that these fatty acids and alcohols may include a substituent group such as a lower alkyl group, an amino group, and halogen, for example, within the range not impairing the effect of the present invention as long as these fatty acids and alcohols have a carbon number of 5 or more of a straight-chain structure.

The foregoing monoester wax is obtained in which, for example, two moles of a saturated long-chain linear alcohol is put into a round flask equipped with a stirrer and a capacitor with respect to one mole of a saturated long-chain linear fatty acid 1 moles, a slight amount of sulfuric acid was added, the mixture was heated and refluxed at a temperature of about 130° C. for four hours, excess alcohol is removed, and the reminder is purified with methyl ether, for example.

Another example of the synthetic ester wax for use includes a triester wax synthesized from a boric acid and a saturated long-chain linear alcohol. For this boric acid, anhydrous boric acid or boron trichloride is used.

In a synthesization method for ethyl borate, three moles of a saturated long-chain linear alcohol is put into a round flask equipped with a stirrer with respect to one mole of anhydrous boric acid, the mixture is reacted generally at a temperature of about 120° C. or more, and ethyl borate is manufactured. After that, the reminder is purified and obtained with alcohol, ether, or the like.

Still another example of the synthetic ester wax includes oligoester wax synthesized from a neopentyl polyol, a dicarboxylic acid, and a saturated long-chain linear fatty acid. For examples of the neopentyl polyols, neopentyl glycol, trimethylolpropane, pentaerythritol, or the like is named. Pentaerythritol is preferable because storage life is the most excellent among these neopentyl polyols. Examples of the dicarboxylic acids include: saturated aliphatic dicarboxylic acids including oxalic acid, malonic acid, succinic acid, glutaric acid, adipic acid, heptanedioic acid, octanedioic acid, azelaic acid, sebacic acid; aliphatic unsaturated dicarboxylic acids including maleic acid and fumaric acid; and aromatic dicarboxylic acids including phthalic acid, isophthalic acid, and terephthalic acid; and the like. Short-chain aliphatic dicarboxylic acids such as oxalic acid, malonic acid, maleic acid, and fumaric acid are preferable among these dicarboxylic acids because the temperature of the melting point is low, and fixity is improved.

In a synthesization method for the oligoester wax, neopentyl polyol, dicarboxylic acid, and a saturated long-chain linear fatty acid are put into a round flask equipped with a stirrer and a capacitor, a slight amount of sulfuric acid is added, and the mixture is heated and refluxed at a temperature of about 130° C. for four hours. After that, the reminder is purified with methyl ether, for example, and the oligoester wax is obtained.

Preferably, the ester wax has a peak temperature of 40 to 90° C. in the quantity of heat absorbed by differential scanning calorimetry (DSC). Low-temperature fixity becomes more excellent as the temperature becomes lower. When the temperature is less than a temperature of 40° C., it is likely that the storage life of the toner is degraded, whereas when the temperature is more than a temperature of 90° C., it is likely that the fixing characteristics at low temperatures is degraded, and low temperatures are not preferable.

Preferably, the content (the weight ratio) of the release agent in the toner is 1% or more and 20% or less with respect to the total amount of toner base particles.

This is because in the case where the content is less than 1%, the wax is insufficiently exuded from the inside of the toner in fixing, the releasing characteristics from the image surface are inferior, and gloss unevenness on the image surface is degraded. In the case where the content is more than 20%, a wax is exuded from the toner surface too much in fixing, the wax contaminates a paper carriage roller or the like in the apparatus, parts lifetime is impaired, and problems arise.

The melting point of the release agent means the temperature of a heat absorption peak at which the quantity of heat absorbed is the maximum in differential thermal curves obtained by differential scanning calorimetry (DSC) (referred to as “the maximum heat absorption peak temperature”).

Preferably, the heat absorption peak temperature of a crystalline polyester resin measured according to differential scanning calorimetry (DSC) is a temperature of 50° C. or more and a temperature of 150° C. or less.

This is because in the case where the temperature is less than a temperature of 50° C., the heat storage life of toner is degraded, the toner becomes solid in the process of storage, and flowability becomes inferior. In the case where temperature is more than a temperature of 150° C., a wax is not easily exuded from the inside of a toner particle in fixing, the releasing characteristics from the image surface are inferior, and gloss unevenness on the image surface is degraded.

Preferably, the volume average particle diameter of the toner base particle is 3.0 μm or more and less than 6.0 μm.

This is because in the case where the diameter is less than 3.0 μm, a development sleeve is prone to be fastened because there are too many fine particles, whereas in the case where the diameter is more than 6.0 μm, the total surface area of a toner particle is reduced, a wax is not easily exuded from the inside of a toner particle, the releasing characteristics from the image surface are inferior, and gloss unevenness on the image surface is degraded.

Preferably, a particle diameter ratio which is a value that the volume average particle diameter of the toner base particle is divided by a number average particle diameter is 1.05 or more and 1.25 or less.

This is because in the case where the particle diameter ratio is less than 1.05, it is demanded to eliminate a considerable amount of fine particles in order to make an even toner dispersion, and productivity is seriously degraded, whereas in the case where the particle diameter ratio is more than 1.25, the particle diameter distribution becomes to wide, it is difficult to uniformly exude a wax to the toner surface, the releasing characteristics from the image surface are inferior, and gloss unevenness on the image surface is degraded.

The toner materials which are toner raw materials will be in turn described.

(Crystalline Polyester)

Since crystalline polyesters are the same as the foregoing crystalline polyesters, the description is omitted.

Next, the experiments conducted by the present inventors will be described.

In order to obtain toners of various properties, the present inventors first prepared toner materials as described below.

<Synthesization of Organic Fine Particle Emulsion>

In a reaction chamber to which a stirring rod and a thermometer are set, 700 parts by weight of water, 12 parts by weight of sodium salt of ethylene oxide methacrylate adduct sulfuric acid ester (ELEMINOL RS-30 (made by Sanyo Chemical Industry Co, Ltd.)), 140 parts by weight of styrene, 140 parts by weight of methacrylic acid, and 1.5 parts by weight of ammonium persulfate were included. Then, the mixture was stirred at a 45° rotation/minute for 20 minutes to obtain a white emulsion, the temperature of the emulsion was increased to a system temperature of 75° C., and the emulsion was reacted for five hours. 35 parts by weight of ammonium persulfate aqueous solution (1%) was added to the emulsion, the mixture was maturated for five hours at a temperature of 75° C., and an aqueous dispersion (“fine particle dispersion 1”) of vinyl resins (a odium salt copolymer of styrene-methacrylic acid-ethylene oxide methacrylate adduct sulfuric acid ester) was obtained. When the volume average particle diameter of this fine particle dispersion 1 was measured using LA-920, the particle diameter was 0.30 μm. A part of “fine particle dispersion 1” was dried to isolate a resin portion. Tg of the resin portion was a temperature of 155° C.

<Preparation of an Aqueous Phase>

1,000 parts by weight of water, 85 parts by weight of “fine particle dispersion 1”, 40 parts by weight of an aqueous solution (50%) of dodecyldiphenyl ether disulfonic acid sodium (ELEMINOL MON-7 (made by Sanyo Chemical Industry Co, Ltd.)), and 95 parts by weight of acetic acid ethyl were mixed and stirred, and a translucent white liquid was obtained. The mixture was “aqueous phase 1”.

<Synthesization of a Low Molecule Polyester (a Polyester Including a Hydroxyl Group)>

In a reaction chamber equipped with a cooling pipe, a stirrer, and nitrogen introduction pipe, 235 parts by weight of a bisphenol A ethylene oxide (two moles) adduct, 535 parts by weight of a bisphenol A propylene oxide (three moles) adduct, 215 parts by weight of terephthalic acid, 50 parts by weight of adipic acid, and 3 parts by weight of dibutyltin oxide were included. The mixture was reacted at a temperature of 240° C. for ten hours under a normal pressure, and then reacted at a reduced pressure of 10 to 20 mmHg for six hours. After that, 45 parts of trimellitic anhydrid was put into a reaction chamber, the mixture was reacted at a temperature of 185° C. at a normal pressure for three hours, and “low-molecular polyester 1” was obtained. This “low-molecular polyester 1” had a number average molecular weight of 2,800, a weight average molecular weight of 7,100, Tg of 45° C., and an acid value of 22 mgKOH/g.

<Synthesization of Polyester Prepolymer (Polyester Prepolymer Including an Isocyanate Group)>

In a reaction chamber equipped with a cooling pipe, a stirrer, and nitrogen introduction pipe, 700 parts by weight of a bisphenol A ethylene oxide (two moles) adduct, 85 parts by weight of a bisphenol A propylene oxide (two moles) adduct, 300 parts by weight of terephthalic acid, 25 parts of trimellitic anhydrid, and 3 parts by weight of dibutyltin oxide were included. The mixture was reacted at a normal pressure at a temperature of 240° C. for ten hours, and reacted under an environment at a reduced pressure of 10 to 20 mmHg for six hours, and “intermediate polyester 1” was obtained. This “intermediate polyester 1” had a number average molecular weight of 2,500, a weight average molecular weight of 10,000, Tg of 58° C., an acid value of 0.5 mgKOH/g, and a hydroxyl value of 52 mgKOH/g.

Subsequently, in a reaction chamber equipped with a cooling pipe, a stirrer, and nitrogen introduction pipe, 400 parts by weight of “intermediate polyester 1”, 90 parts by weight of isophoronediisocyanate, and 500 parts of acetic acid ethyl were included. The mixture was then reacted at a temperature of 110° C. for six hours, and “prepolymer 1” was obtained. The percent by weight of free isocyanate of “prepolymer 1” was 1.67%.

<Synthesization of Crystalline Polyester 1>

In a five-liter four-necked flask equipped with a nitrogen introduction pipe, a dewatering pipe, a stirrer, and a thermocouple, 28 moles of 1,4-butanediol, 24 moles of fumaric acid, 1.80 moles of trimellitic anhydrid, and 6.0 g of hydroquinone were included. The mixture was reacted at a temperature of 160° C. for six hours, and a temperature was increased at a temperature of 200° C. to react the mixture. The mixture was reacted at a pressure of 8.3 KPa for one hour, and “crystalline polyester 1” was obtained. This “crystalline polyester 1” had a melting point (a heat absorption peak temperature by DSC) 150° C., Mn of 800, and Mw of 3,000.

<Synthesization of Crystalline Polyester 2>

In a five-liter four-necked flask equipped with a nitrogen introduction pipe, a dewatering pipe, a stirrer, and a thermocouple, 28 moles of 1,4-butanediol, 24 moles of fumaric acid, 1.80 moles of trimellitic anhydrid, 6.0 g of hydroquinone were included. The mixture was reacted at a temperature of 120° C. for three hours, and the temperature was increased at a temperature of 180° C. for 0.5 hour. The mixture was reacted at a pressure of 8.3 KPa for 0.5 hour, and “crystalline polyester 2” was obtained. This “crystalline polyester 2” had a melting point (a heat absorption peak temperature by DSC) of 50° C., Mn of 500, and Mw of 1,000.

<Synthesization of Ketimine>

In a reaction chamber to which a stirring rod and a thermometer are set, 180 parts by weight of isophorone diamine and 80 parts by weight of methylethyl ketone were included, the mixture was reacted at a temperature of 50° C. for six hours, and “ketimine compound I” was obtained.

The amine value of “ketimine compound I” was 420 mgKOH/g.

<Synthesization of a Masterbatch (MB)>

1,300 parts by weight of water, 550 parts by weight of carbon black (Printex 35 made by DEGUSSA) (DBP oil absorption=43 ml/100 mg, pH=9.5), and 1,300 parts by weight of polyester were added, and the mixture was mixed using Henschel mixer (made by Mitsui Mining Co., Ltd.,). The mixture was kneaded using a two-roll mill at a temperature of 160° C. for 45 minutes, rolled and cooled, and pulverized using a pulverizer, and “master batch 1” was obtained.

<Preparation of an Oil Phase (Pigment-Wax Dispersion 1)>

In a container in which a stirring rod and a thermometer were set, 400 parts by weight of “low-molecular polyester 1”, 100 parts by weight of a microcrystalline wax (an acid value of 0.1 mgKOH/g, a melting point of 65° C., a carbon number of 20, and 70 percent by weight of straight-chain hydrocarbon), 20 parts by weight of CCA (salicylic acid metal complex E-84 made by Orient Chemical Industries Co., Ltd.), and acetic acid ethyl 1,000 parts by weight were included. The temperature was increased at a temperature of 80° C. while stirring the mixture, and the mixture was allowed stand for eight hours at a temperature of 80° C., and cooled at a temperature of 24° C. for one hour. Subsequently, 480 parts by weight of “masterbatch 1” and 550 parts of acetic acid ethyl were included in the container, the mixture was mixed for one hour, and “raw material dissolved solution 1” was obtained. This “raw material dissolved solution 1” was included in a different container, and 80 percent by volume of zirconia beads in a diameter of 0.5 mm was filled at a flowing velocity of 1 kg/hr and a disk circumferential velocity of 6 m/second using a bead mill (Ultra Visco Mill, made by Aimex CO., Ltd). Carbon black and a wax were then dispersed under the three-path conditions. After that, 1,000 parts by weight of 65% acetic acid ethyl solution of “low-molecular polyester 1” were added, the mixture was passed using the bead mill under the foregoing conditions, and “pigment-wax dispersion 1” was obtained. The solid content density of “pigment-wax dispersion 1” was 53 percent by weight (at a temperature of 130° C. for 30 minutes).

<Preparation of an Oil Phase (Pigment-Wax Dispersion 2)>

“Pigment-wax dispersion 2” was obtained as similarly prepared as “pigment-wax dispersion 1” except that 100 parts by weight of a microcrystalline wax (an acid value of 0.1 mgKOH/g, a melting point of 65° C., a carbon number of 20, and 70 percent by weight of straight-chain hydrocarbon) used in the preparation of “pigment-wax dispersion 1” was changed to 100 parts by weight of pentaerythritol wax.

<Preparation of an Oil Phase (Pigment-Wax Dispersion 3)>

“Pigment-wax dispersion 3” was obtained as similarly prepared as “pigment-wax dispersion 1” except that 100 parts by weight of a microcrystalline wax (an acid value of 0.1 mgKOH/g, a melting point of 65° C., a carbon number of 20, and 70 percent by weight of straight-chain hydrocarbon) used in the preparation of “pigment-wax dispersion 1” was changed to 100 parts by weight of a microcrystalline wax (an acid value of 0.1 mgKOH/g, a melting point of a temperature of 90° C., a carbon number of 80, and 55 percent by weight of straight-chain hydrocarbon).

<Preparation of an Oil Phase (Pigment-Wax Dispersion 4)>

“Pigment-wax dispersion 4” was obtained as similarly prepared as “pigment-wax dispersion 1” except that 100 parts by weight of a microcrystalline wax (an acid value of 0.1 mgKOH/g, a melting point of 65° C., a carbon number of 20, and 70 percent by weight of straight-chain hydrocarbon) used in the preparation of “pigment-wax dispersion 1” was changed to 100 parts by weight of a microcrystalline wax (an acid value of 0.1 mgKOH/g, a melting point of a temperature of 90° C., a carbon number of 85, and 50 percent by weight of straight-chain hydrocarbon).

<Preparation of an Oil Phase (Pigment-Wax Dispersion 5)>

“Pigment-wax dispersion 5” was obtained as similarly prepared as “pigment-wax dispersion 1” except that 100 parts by weight of a microcrystalline wax (an acid value of 0.1 mgKOH/g, a melting point of 65° C., a carbon number of 20, and 70 percent by weight of straight-chain hydrocarbon) used in the preparation of “pigment-wax dispersion 1” was changed to 100 parts by weight of natural carnauba wax.

<Preparation of a Crystalline Polyester Dispersion>

110 g of “crystalline polyester 1” and 450 g of acetic acid ethyl were put into a two-liter metal container, and the mixture was heated and dissolved or heated and dispersed at a temperature of 80° C., and quickly cooled in an ice-water bath. 500 ml of glass beads (a diameter of 3 mm) was added in the mixture, and stirred for ten hours using a batch sand mill device (made by Kanpe Hapio Co., Ltd.), and “crystalline polyester dispersion 1” having a volume average particle diameter of 0.4 μm was obtained.

Moreover, “crystalline polyester dispersion 2” was obtained similarly as described above except that 110 g of “crystalline polyester 1” was changed to 110 g of “crystalline polyester 2”.

Next, the present inventors manufactured toners for use in examples and comparative examples described below using these materials. It is noted that in the following, the conditions for the comparative examples will be described together with the examples.

### Example 1

First, the following emulsification process step was performed. Namely, 700 parts by weight of “pigment-wax dispersion 1”, 120 parts by weight of “prepolymer 1”, 80 parts by weight of “crystalline polyester dispersion 1”, and 15 parts by weight of ketimine compound were put into a container. The mixture was mixed at 6,000 rpm for one minute using TK homo mixer (made by Primix Corporation), 11,300 parts by weight of aqueous phase was added into the container, the mixture was mixed at a number of revolutions 13,000 rpm for 20 minutes using TK homo mixer, and “emulsification slurry 1” was obtained.

Subsequently, the following desolvation process step was performed. Namely, “emulsification slurry 1” was put into a container in which a stirrer and a thermometer were set, desolvated at a temperature of 30° C. for ten hours, the mixture was maturated at a temperature of 45° C. for five hours, and “dispersion slurry 1” was obtained.

After that, 100 parts by weight of “emulsification slurry 1” was filtered at a reduced pressure.

(1) 100 parts by weight of ion ion-exchanged water were added in a filter cake, mixed at a number of revolutions of 12,000 rpm using TK homo mixer, and then filtered.

(2) 100 parts by weight of 10% sodium hydrate aqueous solution were added to the filter cake in (1), mixed at a number of revolutions of 12,000 rpm using TK homo mixer, and filtered at a reduced pressure.

(3) 100 parts by weight of 10% hydrochloric acid were added to the filter cake in (2), mixed at a number of revolutions of 12,000 rpm for 10 minutes using TK homo mixer, and then filtered.

(4) 300 parts by weight of ion ion-exchanged water were added to the filter cake in (3), mixed at a number of revolutions of 12,000 rpm for 10 minutes using TK homo mixer, filtered twice, and “filter cake 1” was obtained. This “filter cake 1” was dried at a temperature of 45° C. for 48 hours using a circulation dryer, and sieved through a mesh having an aperture of 75 μm, and “toner base particles 1” was obtained.

0.4 parts by weight of hydrophobic silica (an average number particle diameter of 10 nm) and 0.4 parts by weight of hydrophobic titanium oxide (an average number particle diameter of 15 nm) were mixed with respect to 100 parts by weight of “toner base particles 1” thus obtained using Henschel mixer, and toner including a toner base particle was formed. The toner volume average particle diameter was 6 μm, and the toner particle diameter ratio was 1.25.

For the conditions in evaluation of gloss unevenness, such a fixing unit was used in which the system linear velocity was 1,700 mm/sec, the layer thickness L1 of silicone rubber corresponding to the rubber layer 92b was 750 μm, and the layer thickness L2 of fluorine resin corresponding to the releasing layer 92c was 20 μm.

### Example 2

Experiments were similarly conducted as in Example 1 except that a system linear velocity of 1,700 mm/sec was changed to a system linear velocity of 400 mm/sec as the conditions in evaluation of gloss unevenness with respect to the conditions in Example 1.

### Example 3

Experiments were similarly conducted as in Example 1 except that such a fixing unit is used in which the layer thickness L1 of silicone rubber was changed to 400 μm and the layer thickness L2 of fluorine resin was changed to 2 μm for the conditions in evaluating gloss unevenness with respect to the conditions in Example 1.

### Example 4

Experiments were similarly conducted as in Example 1 except that 80 parts by weight of “crystalline polyester dispersion 1” used in Example 1 was changed to 5 parts by weight with respect to the conditions in Example 1.

### Comparative Example 1

Experiments were similarly conducted as in Example 1 except that 80 parts by weight of “crystalline polyester dispersion 1” used in Example 1 was changed to 4 parts by weight.

### Comparative Example 2

Experiments were similarly conducted as in Example 1 except that such a fixing unit is used in which the layer thickness L1 of silicone rubber was changed to 380 μm and the layer thickness L2 of fluorine resin was changed to 25 μm for the conditions in evaluating gloss unevenness in Example 1.

### Comparative Example 3

Experiments were similarly conducted as in Example 1 except that such a fixing unit is used in which the layer thickness L1 of silicone rubber was changed to 800 μm and the layer thickness L2 of fluorine resin was changed to 1 μm for the conditions in evaluating gloss unevenness in Example 1.

### Example 5

Experiments were similarly conducted as in Example 1 except that “pigment-wax dispersion 1” used in Example 1 was changed to “pigment-wax dispersion 2” with respect to the conditions in Example 1.

### Example 6

Experiments were similarly conducted as in Example 1 except that “pigment-wax dispersion 1” used in Example 1 was changed to “pigment-wax dispersion 3” with respect to the conditions in Example 1.

### Comparative Example 4

Experiments were similarly conducted as in Example 1 except that “pigment-wax dispersion 1” used in Example 1 was changed to “pigment-wax dispersion 4”.

### Comparative Example 5

Experiments were similarly conducted as in Example 1 except that “pigment-wax dispersion 1” used in Example 1 was changed to “pigment-wax dispersion 5”.

### Example 7

Experiments were similarly conducted as in Example 1 except that 700 parts by weight of “pigment-wax dispersion 1” used in Example 1 was changed to 35 parts by weight with respect to the conditions in Example 1.

### Example 8

Experiments were similarly conducted as in Example 1 except that “crystalline polyester dispersion 1” used in Example 1 was changed to “crystalline polyester dispersion 2” with respect to the conditions in Example 1.

### Example 9

Experiments were similarly conducted as in Example 1 except that a toner volume average particle diameter of 6 μm used in Example 1 was changed to 3 μm and a toner particle diameter ratio of 1.25 was changed to 1.05 with respect to the conditions in Example 1.

### Example 10

Experiments were similarly conducted as in Example 1 except that 0.4 parts by weight of hydrophobic silica used in Example 1 (an average number particle diameter of 10 nm) and 0.4 parts by weight of hydrophobic titanium oxide (an average number particle diameter of 15 nm) were changed to 1.2 parts by weight of hydrophobic silica (an average number particle diameter of 10 nm), 3.0 parts by weight of a large particle diameter hydrophobic silica (an average number particle diameter of 120 nm), and 0.8 parts by weight of hydrophobic titanium oxide (an average number particle diameter of 15 nm) with respect to the conditions in Example 1.

The melting point of the release accelerator means the temperature of a heat absorption peak at which the quantity of heat absorbed is the maximum in differential thermal curves obtained by differential scanning calorimetry (DSC). The heat absorption peak temperature of a crystalline polyester resin was also measured by differential scanning calorimetry.

Next, the present inventors analyzed each toner of Examples and Comparative Examples on the infrared absorption spectra of a crystalline polyester resin or an amorphous polyester resin of a binder resin, and the result illustrated in FIGS. 4 and 5 was obtained. Infrared spectroscopic analysis was conducted by a KBr method (a total transmission method) using Avatar 370, which is an FT-IR (Fourier transform infrared spectrometer) made by ThermoElectron Corporation. The infrared absorption spectrum is a graph that the wave number of an infrared ray applied was plotted on the horizontal axis of two-dimensional coordinates and the absorbance was plotted on the vertical axis. Thus, it is revealed what structure a substance to be analyzed has.

It is noted that the infrared absorption spectrum of the crystalline polyester resin and the infrared absorption spectrum of an amorphous polyester resin on infrared spectroscopic analysis are as illustrated in FIGS. 4 and 5, and the forgoing description on the spectra is omitted.

As similar to the foregoing experimental conditions, the present inventors mixed each toner in a copper-zinc ferrite carrier, and a plurality of types of developers was manufactured. For the mixing ratio, a copper-zinc ferrite carrier was 90 percent by weight with respect to 10 percent by weight of the toner. For the mixing conditions, such conditions were adopted in which the mixture was mixed and stirred at a number of revolutions 71 rpm for five minutes using Turbula shaker mixer (Shinmaru Enterprises Corporation). For the copper-zinc ferrite carrier, such a carrier was used in which silicone resin was covered and an average particle diameter was 40 μm.

The developers were individually used to conduct printing tests. For a printer for use in the printing tests, RICOH Proc 901 (made by Ricoh Company, Ltd.) was altered in the configuration of the present invention for evaluation. The system velocity (B (mm/sec)), the coverage rate (6%), and the number of paper sheets outputted (50 thousands sheets) in evaluation were the same as the conditions in the experiments in the foregoing forms.

In the printing tests, a test image at a coverage rate of 6% was continuously outputted on 50 thousands A3 size paper sheets. After the output, a single dot line was outputted as a sample image on three A3 size paper sheets, and gloss unevenness on the image surfaces of the sheets was visually evaluated. For the evaluation, sensory evaluation was conducted in which a single dot line image for a preprinted rank sample was visually compared with the sample image. A significantly excellent case was expressed by a double circle, an excellent case was expressed by a circle, a relatively poor case was expressed by a triangle, and a poor case was expressed by a cross for evaluation.

The experimental results are shown in Table 2 below.

TABLE 2

| | | | | | | | Wax | Wax Dsc | Wax | DSC Heat | Toner | | |
|---|---|---|---|---|---|---|---|---|---|---|---|---|---|
| | | | | | | | Straight- | Heat | Content | Absorp- | Volume | | |
| | | | | | Organic | Wax | Chain | Absorp- | Of Toner | tion Peak | Average | | |
| | System | | | | Fine | Carbon | Hydro- | tion Peak | Base | Tempera- | Particle | Particle | Gloss |
| | Velocity | L1 | L2 | | Particle | Number | carbon | Tempera- | Particle | ture Of C- | Diameter | Diameter | Uneven- |
| | (mm/sec) | (μm) | (μm) | W/R | Number | (%) | Content | ture (° C.) | (wt/%) | Poly (° C.) | (μm) | Ratio | ness |
| Example 1 | 1700 | 750 | 20 | 0.85 | 0.80 | 20 | 70 | 65 | 20 | 150 | 6 | 1.25 | ◯ |
| Example 2 | 400 | 750 | 20 | 0.85 | 0.80 | 20 | 70 | 65 | 20 | 150 | 6 | 1.25 | ⊙ |
| Example 3 | 1700 | 400 | 2 | 0.85 | 0.80 | 20 | 70 | 65 | 20 | 150 | 6 | 1.25 | ⊙ |
| Example 4 | 1700 | 750 | 20 | 0.045 | 0.80 | 20 | 70 | 65 | 20 | 150 | 6 | 1.25 | ◯ |
| Compara- | 1700 | 750 | 20 | 0.043 | 0.80 | 20 | 70 | 65 | 20 | 150 | 6 | 1.25 | X |
| tive | | | | | | | | | | | | | |
| Example 1 | | | | | | | | | | | | | |
| Compara- | 1700 | 380 | 25 | 0.85 | 0.80 | 20 | 70 | 65 | 20 | 150 | 6 | 1.25 | X |
| tive | | | | | | | | | | | | | |
| Example 2 | | | | | | | | | | | | | |
| Compara- | 1700 | 800 | 1 | 0.85 | 0.80 | 20 | 70 | 65 | 20 | 150 | 6 | 1.25 | X |
| tive | | | | | | | | | | | | | |
| Example 3 | | | | | | | | | | | | | |
| Example 5 | 1700 | 750 | 20 | 0.85 | 0.80 | | | | 20 | 150 | 6 | 1.25 | ⊙ |
| Example 6 | 1700 | 750 | 20 | 0.85 | 0.80 | 80 | 55 | 90 | 20 | 150 | 6 | 1.25 | ◯ |
| Compara- | 1700 | 750 | 20 | 0.85 | 0.80 | 85 | 50 | 92 | 20 | 150 | 6 | 1.25 | X |
| tive | | | | | | | | | | | | | |
| Example 4 | | | | | | | | | | | | | |
| Compara- | 1700 | 750 | 20 | 0.85 | 0.80 | | | | 20 | 150 | 6 | 1.25 | X |
| tive | | | | | | | | | | | | | |
| Example 5 | | | | | | | | | | | | | |
| Example 7 | 1700 | 750 | 20 | 0.85 | 0.80 | 20 | 70 | 65 | 1 | 150 | 6 | 1.25 | ◯ |
| Example 8 | 1700 | 750 | 20 | 0.85 | 0.80 | 20 | 70 | 65 | 20 | 50 | 6 | 1.25 | ⊙ |
| Example 9 | 1700 | 750 | 20 | 0.85 | 0.80 | 20 | 70 | 65 | 20 | 150 | 3 | 1.05 | ◯ |
| Example | 1700 | 750 | 20 | 0.85 | 5.00 | 20 | 70 | 65 | 20 | 150 | 6 | 1.25 | ◯ |
| 10 | | | | | | | | | | | | | |

For example, in the present invention, the foregoing exemplary configurations can be applied not only to an image forming apparatus of a so-called tandem system like the image forming apparatus 100 but also similarly to a so-called single drum image forming apparatus in which color toner images are in turn formed on an image carrier such as a single photosensitive drum, color toner images are in turn laid on each other, and a color image is obtained, and can also be applied to a monochrome image forming apparatus, not a color image forming apparatus. A direct transfer method may be adopted in which color toner images are directly transferred to a recording medium such as a transfer paper sheet, with no use of the intermediate transfer body in any types of image forming apparatuses.

The effects described in the embodiment of the present invention are merely a list of the most preferable effects derived from the present invention, and the effects exerted by the present invention are not limited to ones described in the embodiment of the present invention.

According to the present invention, the release agent in the toner is exuded to the toner surface neither too much nor too little in fixing when images are formed at high speed, and gloss unevenness produced in fixing is sufficiently avoided, so that it is possible to obtain an image forming apparatus that can form images excellently.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus that performs image formation using toner at a system velocity of 400 to 1,700 mm/sec, the image forming apparatus comprising:
an endless fixing belt that transports a sheet medium on which a toner image is carried, wherein
the fixing belt includes:
a base layer;
a rubber layer, as an elastic layer, formed of a silicon rubber on the base layer; and
a releasing layer formed of a fluorine resin on the rubber layer,
a layer thickness L2 of the fluorine resin is in a range of 2≦L2≦20 μm,
a layer thickness L1 of the silicone rubber is in a range of 400≦L1≦750 μm,
the toner includes at least a release agent and a binder resin, the binder resin including at least a crystalline polyester resin and an amorphous polyester resin,
a ratio W/R of a height W of third falling peak of an infrared absorption spectrum of the crystalline polyester resin to a height R of the maximum rising peak of an infrared absorption spectrum of the amorphous polyester resin, which are measured by an infrared spectroscopy (a KBr pellet method) using Fourier transform infrared spectrometer, is 0.045 or more and 0.850 or less, and
the content of inorganic fine particles is from 0.80 to 5.00 parts per 100 parts of toner base particles.

2. The image forming apparatus according to claim 1, wherein
the release agent includes a microcrystalline wax as a release accelerator, and
the microcrystalline wax is formed of a hydrocarbon having a carbon number of 20 or more and 80 or less, a straight-chain hydrocarbon content of the hydrocarbon is 55 to 70 percent by weight, and a heat absorption peak temperature measured by using differential scanning calorimetry is 65° C. or more and 90° C. or less.

3. The image forming apparatus according to claim 1, wherein the release agent content in the toner base particle is 1% or more and 20% or less.

4. The image forming apparatus according to claim 1, wherein a heat absorption peak temperature of a polyester resin used as the binder resin measured by using differential scanning calorimetry is 50° C. or more and 150° C. or less.

5. The image forming apparatus according to claim 1, wherein a volume average particle diameter of the toner base particle of the toner is 3.0 μm or more and less than 6.0 μm.

6. The image forming apparatus according to claim 1, wherein a particle diameter ratio which is a value obtained by dividing a volume average particle diameter of the toner base particle of the toner by a number average particle diameter thereof is 1.05 or more and 1.25 or less.

7. The image forming apparatus according to claim 1, wherein the toner is manufactured by a manufacturing method including:
putting at least a binder resin, a binder resin precursor, or a binder resin and a binder resin precursor, and a release accelerator into an organic solvent to prepare a toner solution;
putting the toner solution into an aqueous medium to obtain an emulsion or a dispersion; and
forming the toner base particles while removing the solvent from the emulsion or the dispersion.

8. The image forming apparatus according to claim 1, further comprising:
a fixing roller and a heating roller on which the fixing belt is wound, the heating roller including a heat source inside;
a pressing roller that is disposed at a position opposite to the fixing belt through the fixing belt and press the fixing belt; and
a temperature detecting unit that is disposed near the fixing belt and detects a surface temperature of the fixing belt.

9. The image forming apparatus according to claim 1, wherein the image forming apparatus enables image formation for 70 sheets or more of the sheet media in an A4 size for one minute.

10. An image forming apparatus that performs image formation using toner at a system velocity of 400 to 1,700 mm/sec, the image forming apparatus comprising:
an endless fixing belt that transports a sheet medium on which a toner image is carried, wherein
the fixing belt includes:
a base layer;
a rubber layer formed of a silicon rubber on the base layer; and
a releasing layer formed of a fluorine resin layer on the rubber layer,
a layer thickness L2 of the fluorine resin is in a range of 2≦L2≦20 μm,
a layer thickness L1 of the silicone rubber is in a range of 400≦L1≦750 μm,
the toner includes at least a release agent, a binder resin, and an inorganic fine particle;
the release agent for use includes a microcrystalline wax, a synthetic ester wax, or a microcrystalline wax and a synthetic ester wax;
the toner includes at least a crystalline polyester resin and an amorphous polyester resin as the binder resin,
a ratio W/R of a height W of third falling peak of an infrared absorption spectrum of the crystalline polyester resin to a height R of the maximum rising peak of an infrared absorption spectrum of the amorphous polyester resin, which are measured by an infrared spectroscopy (a KBr pellet method) using Fourier transform infrared spectrometer, is 0.045 or more and 0.850 or less, and
the content of inorganic fine particles is from 0.4 to 5.0 parts by weight per 100 parts of a toner base particles.

11. The image forming apparatus according to claim 10, wherein the synthetic ester wax is a mono ester wax obtained from a saturated long-chain linear fatty acid and a saturated long-chain alcohol.
